(19) United States
(12) Patent Application Publication
(10) Pub. No.: US 2012/0303218 A1
(43) Pub. Date: Nov. 29, 2012

(54) ELECTRIC STEERING DEVICE

(75) Inventors: Norifumi Tamura, Saitama (JP); Yoshinobu Tada, Saitama (JP); Yoshiyuki Matsumoto, Saitama (JP); Hiroyuki Tokunaga, Saitama (JP)

(73) Assignee: HONDA MOTOR CO., LTD., Tokyo (JP)

(21) Appl. No.: 13/478,943

(22) Filed: May 23, 2012

(30) Foreign Application Priority Data
May 23, 2011 (JP) 2011-114302
May 23, 2011 (JP) 2011-115258

(51) Int. Cl. B62D 6/00; B62D 6/02; B62D 5/04

(52) U.S. Cl. 701/41

(57) ABSTRACT

An electric steering device is provided which enables a stable steering correction operation expected by a driver. An electric power steering device having a motor, which is controlled by a control device based on steering torque and generates steering assist force, further includes operation switches which are provided at a steering wheel and which output electric signals based on an operation given by a driver, and an additional current computing unit that calculates and outputs an additional current value waveform for adding a current for driving the motor in accordance with the electric signals from the operation switches. The additional current computing unit generates and outputs the current waveform of a predetermined additional current value in accordance with the driving condition information on a vehicle in response to an operation to the operation switch regardless of the time length of the ON state of the operation switches.

### CROSS REFERENCE TO RELATED APPLICATION

This application claims the priority of Japanese Applications Nos. 2011-114302, filed on May 23, 2011, and 2011-115258, filed on May 23, 2011, the entire specifications, claims and drawings of which are incorporated herewith by reference.

### BACKGROUND OF THE INVENTION

1. Field of the Invention

The present invention relates to an electric steering device which drives a steering mechanism thorough a motor (a steering motor) or which applies steering assist force to the steering mechanism.

2. Description of the Related Art

An electric power steering device causes a motor to generate steering assist force in accordance with the level of steering wheel torque, transmits the steering assist force to a steering system, thereby reducing the steering effort by a driver. JP 2002-59855 A (see FIG. 2) and JP 2000-177615 A (see FIG. 2) disclose technologies of compensating a base current (assist torque) defined based on steering wheel torque and a vehicle speed by the inertia of the steering system, performing damping correction on such a current, and controls the motor with the compensated or corrected current being as a target current.

Note that only a torque sensor output is input into inertia compensation current value setting means but no vehicle speed signal is input thereto according to JP 2000-177615 A.

JP H10-295151 A (see FIG. 2) discloses a vehicular state level control device that adjusts a yaw rate which is a reference rate calculated from a steering angle and a vehicle speed when a grip provided on a steering wheel that turns the turning wheels is rotated.

Moreover, JP 2008-174006 A (see FIG. 2) discloses an operation device which uses a crawler as a driving device, and which controls the running direction of a work machine like a combine. Such an operation device controls the braking and rotation in the right and left directions by engaging or releasing one of the right and left side clutches and activating the brake at a side where the side clutch in the right and left brakes is released when the steering operation instrument in a steering wheel shape is turned and operated in the right or in the left. Moreover, according to such an operation device, the engagement and release of the right and left side clutches can be performed through a switch provided on the steering operation instrument for correcting the direction.

According to the technologies of adjusting a turning motion by a rotational angle of the grip provided on the steering wheel or the steering operation instrument or the operation of the switch like JP H10-295151 A and JP 2008-174006 A, the turning level is changed depending on the rotational angle of the grip or the operation time of the switch.

For example, provided that a four-wheel vehicle is running substantially straight, when a driver periodically performs steering operation for correction of the vehicle's running direction substantially constantly in the right or left direction in accordance with a change in the road condition, if such a correction steering operation is performed by the driver through the rotational angle of the grip or through the operation of the switch, it is necessary to adjust the rotational angle of the grip and the operation time of the switch, and thus correction of the running direction cannot be simply carried out.

The present invention is to address the above-explained prior-art technical issues, and it is an object of the present invention to provide an electric steering device that enables a stable correction steering operation expected by a driver.

### SUMMARY OF THE INVENTION

To achieve the above object, a first aspect of the present invention provides an electric steering device that includes: an operation unit including a steering wheel operated by a driver, a turning motor that turns turning wheels, and an operation unit which is provided at the steering wheel and which outputs an electric signal in accordance with an operation given by the driver; and a control unit that controls the turning motor based on either one of or both of a steering operation to the steering wheel and the electric signal output by the operation unit. The control unit invalidates the electric signal output by the operation unit based on an operation given by the driver when a steering angle of the steering wheel to a right or a left exceeds a predetermined first threshold.

A second aspect of the present invention provides an electric steering device that includes: an operation unit including a steering wheel operated by a driver, a turning motor that turns turning wheels, and an operation unit which is provided at the steering wheel and which outputs an electric signal in accordance with an operation given by the driver; and a control unit that controls the turning motor based on either one of or both of a steering operation to the steering wheel and the electric signal output by the operation unit. A plurality of the operation units are provided at the steering wheel, and the control unit invalidates the electric signal output by at least one of the plurality of operation units based on an operation given by the driver when a steering angle of the steering wheel to a right or a left exceeds a predetermined first threshold.

A third aspect of the present invention is the electric steering device of the second aspect, in which as the plurality of operation units, a right operation unit and a left operation unit are symmetrically provided at locations in a circumferential direction of the steering wheel with a neutral position direction of the steering wheel being as a symmetrical axis, and the control unit invalidates the electric signal output by the right operation unit based on an operation given by the driver when the steering angle to the right exceeds the predetermined first threshold in right turning of the steering wheel, and invalidates the electric signal output by the left operation unit based on an operation given by the driver when the steering angle to the left exceeds the predetermined first threshold in left turning of the steering wheel.

A fourth aspect of the present invention provides the electric steering device of the third aspect, in which the control unit stores in advance the predetermined first threshold of the steering angle and a predetermined second threshold of the steering angle to the right and left larger than the predetermined first threshold, validates the electric signals output by either one of the right and left operation units when the steering angle to the right and left is equal to or smaller than the predetermined first threshold in turning of the steering wheel, invalidates the electric signal output by the right operation unit based on the operation given by the driver when the steering angle to the right exceeds the predetermined first threshold but is equal to or smaller than the predetermined second threshold in right turning of the steering wheel, invalidates the electric signal output by the left operation unit based on the operation given by the driver when the steering angle to the left exceeds the predetermined first threshold but is equal to or smaller than the predetermined second threshold in left turning of the steering wheel, and invalidates the electric signal output by either one of the right and left operation units when the steering angle to either one of the right and the left exceeds the predetermined second threshold in turning of the steering wheel.

According to the first to fourth aspects of the present invention, when the steering angle of the steering wheel to the right or left exceeds the predetermined first threshold, the control unit invalidates the electric signal output by at least either one of the plurality of operation units based on the operation given by the driver. At this time, with the steering wheel being operated at a large steering angle to the right or left, when the direction of the operation to the operation unit provided at the steering wheel is inverted to the turning direction intended by the driver and the driver feels the difficulty with the operation to the operation unit, the electric signal output by such an operation unit is invalidated.

Hence, when the steering angle of the steering wheel to the right or left exceeds the predetermined first threshold, the right or left operation unit that is easy for the driver to operate can generate and output the predetermined additional current value waveform in accordance with the driving condition information on a vehicle, which facilitates the correction of the predetermined level of steering by the turning motor.

A fifth aspect of the present invention provides the electric steering device of the first or second aspect, in which the control unit makes at least the predetermined first threshold variable in accordance with a vehicle speed.

According to the fifth aspect of the present invention, the control units make the predetermined first threshold of the steering angle of the steering wheel to the right or left variable in accordance with the vehicle speed. Hence, for example, if the predetermined first threshold is set in such a way that the faster the vehicle speed becomes, the smaller the predetermined first threshold becomes, the change level of the turning angle through the operation to the operation unit is permitted while the vehicle is turning at a turning radius that becomes larger as the vehicle speed becomes faster. Accordingly, it prevents the ride comfort from becoming poor due to a change in the lateral acceleration through a steering correction operation using the operation unit at the time of fast-speed turning.

A sixth aspect of the present invention provides the electric steering device of the first or second aspect, in which the control unit comprises an additional current computing unit that calculates and outputs an additional current value waveform for adding a substantially rectangular pulse current for driving the turning motor in accordance with the electric signal output by the operation unit, and the additional current computing unit generates and outputs, in accordance with driving condition information on a vehicle, the predetermined additional current value waveform in accordance with an operation given to the operation unit regardless of a length of an operation time of the operation unit by the driver.

According to the sixth aspect of the present invention, regardless of the length of the switch-on state by the driver using the operation unit provided at the steering wheel, in response to an operation given to the operation unit, the predetermined additional current value waveform can be generated and output in accordance with the driving condition information on the vehicle, and thus the correction of the predetermined level of steering by the turning motor is facilitated.

A seventh aspect of the present invention provides the electric steering device of the sixth aspect which further includes a vehicle speed detecting unit that detects a vehicle speed, in which the additional current computing unit generates and outputs the predetermined additional current value waveform in accordance with the detected vehicle speed.

Force necessary for a turning operation of the turning wheels tends to decrease as the vehicle speed increases. According to the seventh aspect of the present invention, the electric steering device further includes the vehicle speed detecting unit that detects the vehicle speed as the driving condition information on the vehicle, and the additional current computing unit generates and outputs the predetermined additional current value waveform in accordance with the detected vehicle speed. Accordingly, even if the vehicle speed changes, the correction of the predetermined level of steering by the motor is facilitated through an operation to the operation unit.

An eighth aspect of the present invention provides the electric steering device of the sixth aspect, in which the faster the detected vehicle speed becomes, the more the additional current computing unit decreases a wave height of the additional current value waveform, and the slower the detected vehicle speed becomes, the more the additional current computing unit increases the wave height of the additional current value waveform.

According to the eighth aspect of the present invention, the faster the detected vehicle speed becomes, the more the additional current computing unit decreases the wave height of the additional current value waveform, and the slower the detected vehicle speed becomes, the more the additional current computing unit increases the wave height of the additional current value waveform. Hence, it becomes possible for the electric steering device to set the change level of the turning angle by the motor to be a predetermined constant level regardless of the vehicle speed or to set the change level of the turning angle to be smaller as the vehicle speed becomes faster through an operation to the operation unit. Hence, the swaying of the vehicle due to the steering correction operation using the operation unit at the time of fast-speed running can be suppressed, resulting in an improvement of the ride comfort.

A ninth aspect of the present invention provides the electric steering device of the sixth aspect, in which the faster the detected vehicle speed becomes, the more the additional current computing unit decreases a width of the additional current value waveform, and the slower the detected vehicle speed becomes, the more the additional current computing unit increases the width of the additional current value waveform.

According to the ninth aspect of the present invention, the faster the detected vehicle speed becomes, the more the additional current computing unit decreases the width of the additional current value waveform, and the slower the detected vehicle speed becomes, the more the additional current computing unit increases the width of the additional current value waveform. Hence, in combination with the increase-decrease of the wave height of the additional current value waveform, the predetermined change level of the turning angle can be flexibly and easily set through an operation to the operation unit.

A tenth aspect of the present invention provides the electric steering device of the sixth aspect that further includes a steering condition detecting unit that detects whether the operation to the operation unit is a steering increase condition or a return condition, in which the additional current computing unit decreases a wave height or a width of the additional current value waveform when the detected steering condition is the return condition, and increases the wave height or the width of the additional current value waveform when the detected steering condition is the steering increase condition.

In general, when the vehicle speed becomes medium and fast speeds to some level and a vehicle is turning a gentle curve, because of the self-alignment force acting on the turning wheels, in the case of a steering increase operation, a larger steering effort is necessary and in the case of a return steering operation, a smaller steering effort is sufficient.

According to the tenth aspect of the present invention, the additional current computing unit decreases the wave height or the width of the additional current value waveform when the detected steering operation is a return condition, and increases the wave height or the width of the additional current value waveform when the detected steering operation is a steering increase condition. Hence under a condition in which the self-alignment force is acting on the turning wheels, the predetermined change level of the turning angle in accordance with the vehicle speed can be easily set through an operation to the operation unit relative to the steering increase operation and the return steering operation.

An eleventh aspect of the present invention provides the electric steering device of the first or second aspect that further includes: a turning mechanism mechanically isolating a coupling of the turning wheels with the steering wheel; the turning motor that drives the turning mechanism in accordance with a steering operation input through the steering wheel; and a steering reaction force motor that applies steering reaction force to the steering wheel in accordance with the steering operation input through the steering wheel.

According to the eleventh aspect of the present invention, the control unit causes the turning motor to drive the turning mechanism in accordance with a steering input to the steering wheel, and controls the turning motor by generating and outputting the predetermined additional current value waveform depending on the driving condition information on the vehicle in accordance with an operation to the operation unit provided at the steering wheel. This makes it possible for the turning motor to easily correct the predetermined level of steering. That is, the correction of the predetermined level of the steering by the turning motor is facilitated in a steer-by-wire type electric steering device.

### BRIEF DESCRIPTION OF THE DRAWINGS

FIG. 1 is a configuration diagram showing an electric power steering device according to an embodiment of the present invention;

FIG. 2 is an explanatory diagram showing an operation switch provided on a steering wheel shown in FIG. 1;

FIG. 3 is a functional block configuration diagram showing a control device according to a first embodiment;

FIG. 4A is an explanatory diagram for a method of setting a base target current value using a base table by a base signal computing unit;

FIG. 4B is an explanatory diagram for a method of setting a damper correction current value using a damper table by a damper correction signal computing unit;

FIG. 5A is an explanatory diagram for an additional current value waveform in an additional current computing unit shown in FIG. 3, and is an explanatory diagram showing a transition of a time change in an output additional current value;

FIG. 5B is an explanatory diagram for an additional current value waveform in an additional current computing unit shown in FIG. 3, and is an explanatory diagram that the time length of the ON state of an operation switch provided on the steering wheel does not affect an output additional current value waveform;

FIG. 6 is an explanatory diagram for a gain K in a gain setting unit shown in FIG. 3 which sets the wave height of an additional current value waveform in accordance with a vehicle speed VS;

FIG. 7 is an explanatory diagram for a frequency distribution of a steering angle of the steering wheel when an actual vehicle is running;

FIG. 8A is an explanatory diagram for a setting method of a range Rθ_{H} of a steering angle θ_{H} that makes operation of operation switches 2aL and 2aR valid, and is an explanatory diagram when the steering angle θ_{H} is within the predetermined range Rθ_{H};

FIG. 8B is an explanatory diagram for a setting method of a range Rθ_{H} of a steering angle θ_{H} that makes operation of operation switches 2aL and 2aR valid, and is an explanatory diagram when the steering angle θ_{H} is out of the predetermined range Rθ_{H};

FIG. 9A is an explanatory diagram for a transition in the steering angle as time advances and a transition in the steering effort as time advances when a vehicle is running at a slow speed, and is an explanatory diagram for a measurement course;

FIG. 9B is an explanatory diagram for a transition in the steering angle as time advances and a transition in the steering effort as time advances when a vehicle is running at a slow speed, and is an explanatory diagram for transitions in the steering angle and steering effort as time advances when a vehicle is running through the measurement course shown in FIG. 9A;

FIG. 10A is an explanatory diagram for transitions in the steering angle and steering effort as time advances when a vehicle is running at a high speed, and is an explanatory diagram for a measurement course;

FIG. 10B is an explanatory diagram for transitions in the steering angle and steering effort as time advances when a vehicle is running at a high speed, and is an explanatory diagram for transitions in steering angle and steering effort as time advances when a vehicle is running through the measurement course shown in FIG. 10A;

FIG. 11 is a flowchart showing a flow of generation and output controls of an additional current value waveform by the additional current computing unit shown in FIG. 3;

FIG. 12 is a flowchart continuous from FIG. 11;

FIG. 13 is a functional block configuration diagram showing a control device according to a second embodiment;

FIG. 14A is an explanatory diagram for generation of an additional current value waveform by an additional current computing unit shown in FIG. 13, and is an explanatory diagram for setting and changing of the time width of a reference additional current rectangular wave in accordance with a vehicle speed VS;

FIG. 14B is an explanatory diagram for generation of an additional current value waveform by an additional current computing unit shown in FIG. 13, and is an explanatory diagram for a change in the time width of the reference additional current rectangular wave in accordance with the vehicle speed VS;

FIG. 15 is an explanatory diagram for a gain setting the wave height of an additional current value waveform by a gain setting unit shown in FIG. 13 in accordance with a vehicle speed VS;

FIG. 16 is an explanatory diagram for setting a rising time constant τ1 and a falling time constant τ2 in accordance with a vehicle speed VS and used for performing a temporal delay process by an output waveform adjusting unit shown in FIG. 13 on a rectangular pulse waveform that is the current waveform of a reference additional current value;

FIG. 17A is an explanatory diagram for an additional current value waveform in an additional current computing unit shown in FIG. 13, and is an explanatory diagram for a transition of a change in an output additional current value as time advances;

FIG. 17B is an explanatory diagram for an additional current value waveform in an additional current computing unit shown in FIG. 13, and is an explanatory diagram that a time length of an ON state of an operation switch provided on a steering wheel does not affect an output additional current value waveform;

FIG. 18 is a flowchart showing a flow of generation and output controls of an additional current value waveform by the additional current computing unit shown in FIG. 13;

FIG. 19 is a flowchart continuous from FIG. 18;

FIG. 20 is an explanatory diagram for setting of a range Rθ_{H} (a predetermined first threshold) of a steering angle θ_{H} that makes an operation of the operation switch valid and a predetermined second threshold in accordance with a vehicle speed; and

FIG. 21 is an explanatory diagram showing a modified example of an operation switch provided on the steering wheel shown in FIG. 1.

### DETAILED DESCRIPTION OF THE PREFERRED EMBODIMENTS

### First Embodiment

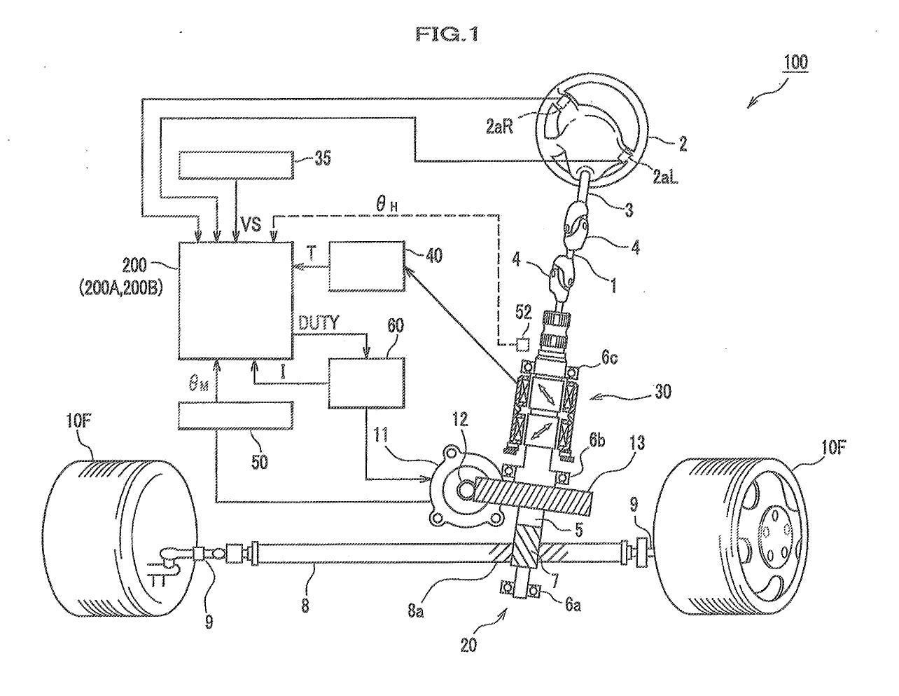

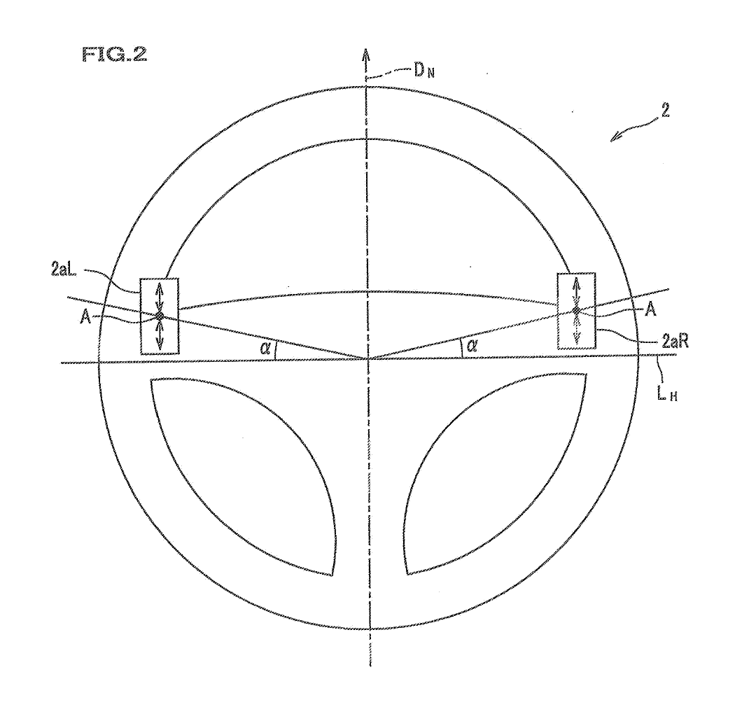

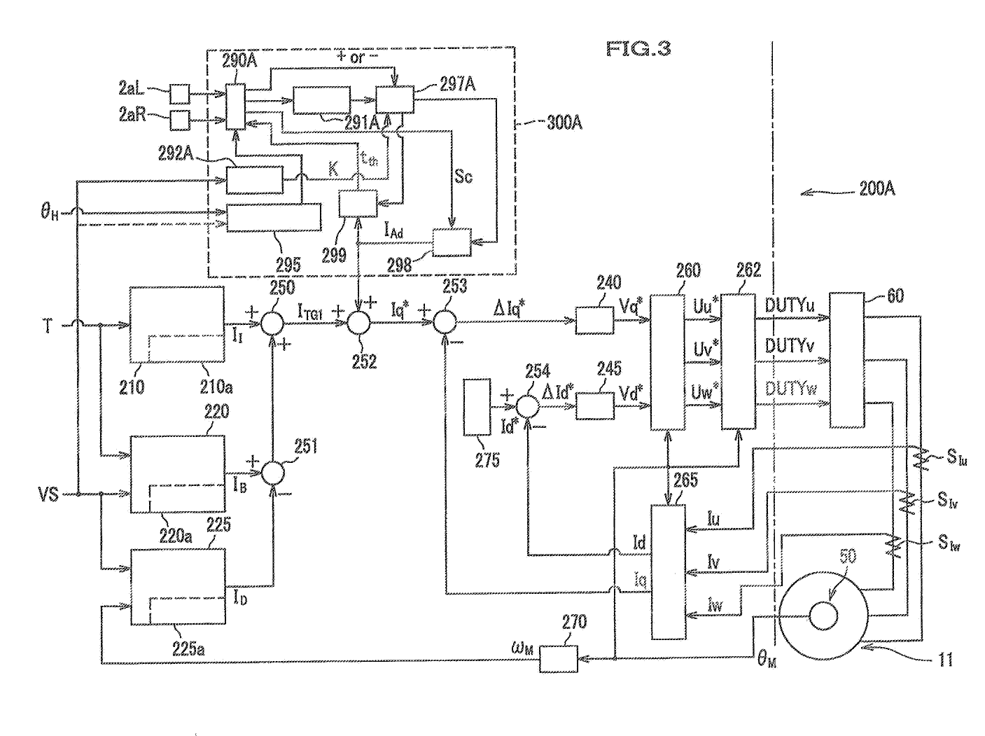

An electric power steering device according to a first embodiment of the present invention will be explained with reference to FIGS. 1 to 3. FIG. 1 is a configuration diagram of an electric power steering device according to this embodiment. FIG. 2 is an explanatory diagram showing an operation switch provided on a steering wheel shown in FIG. 1. FIG. 3 is a functional block configuration diagram of a control device according to the first embodiment.

<Entire Configuration of Electric Power Steering Device>

As shown in FIG. 1, an electric power steering device (an electric steering device) 100 includes a main steering shaft 3 provided with a steering wheel 2, a shaft 1, and a pinion shaft 5 which are coupled together by two universal joints 4, 4. Moreover, a pinion gear 7 provided at the lower end of the pinion shaft 5 is meshed with rack teeth 8a of a rack shaft 8 that can reciprocate in the width direction of a vehicle, and unillustrated knuckle arms of front wheels (turning wheels) 10F, 10F that are right and left turning wheels are coupled with both ends of the rack shaft 8, respectively, via tie rods 9, 9. According to this configuration, the electric power steering device 100 can change the travel direction of the vehicle when the steering wheel 2 is turned (steering input).

The rack shaft 8, the rack teeth 8a, the tie rods 9, 9, and the knuckle arms configure a steering mechanism.

The pinion shaft 5 has the bottom portion, the middle portion, and the upper portion supported by a steering gear box 20 through bearings 6a, 6b, and 6c, respectively.

Moreover, the electric power steering device 100 includes a motor (a steering motor) 11 that supplies steering assist force for reducing the steering effort of a driver to the steering wheel 2. The motor 11 has a worm gear 12 provided at an output shaft of the motor 11 meshed with a worm wheel gear 13 of the pinion shaft 5. That is, the worm gear 12 and the worm wheel gear 13 configure a deceleration mechanism.

The shaft 1, the steering wheel 2, the rotator of the motor 11, the worm gear 12 linked with the motor 11, the worm wheel gear 13, the pinion shaft 5, the rack shaft 8, the rack teeth 8a, and the tie rods 9, 9, etc., configure a steering system.

The motor 11 is a three-phase blushless motor including a stator (unillustrated) with a plurality of field coils and a rotator (unillustrated) rotating in the stator.

Furthermore, the electric power steering device 100 includes a control device (a control unit) 200, an inverter 60 that drives the motor 11, a resolver 50, a steering wheel torque sensor (a torque sensor) 30 that detects pinion torque applied to the pinion shaft 5, i.e., a steering wheel torque T, a differential amplifier circuit 40 that amplifies the output by the steering wheel torque sensor 30, and a vehicle speed sensor (vehicle speed detecting unit) 35.

The electric power steering device 100 may further include a steering angle sensor 52 that detects an operation angle (a steering angle) of the steering wheel 2, a signal indicating a detected steering angle θ_{H} may be input in the control device 200, and the control device 200 may use such information. According to this embodiment, a configuration using the steering angle θ_{H} will be explained.

The steering angle θ_{H} of the steering wheel 2 has a negative (−) sign in the leftward direction from the neutral position and has a positive (+) sign in the rightward direction from the neutral position.

It is representatively expressed as the control device 200 in FIG. 1, but a control device 200A indicated between brackets ( ) corresponds to the control device of the first embodiment, and a control device 200B corresponds to the control device of a second embodiment.

The inverter 60 has a plurality of switching elements like a three-phase FET bridge circuit, and generates a rectangular waveform voltage using a DUTY (in FIG. 3, indicated as “DUTYu”, “DUTYv”, and “DUTYw”) signal from the control device 200 to drive the motor 11. Moreover, the inverter 60 has a function of detecting a three-phase actual current value I (in FIG. 3, indicated as “Iu”, “Iv”, and “Iw”) through current sensors S_{Iu}, S_{Iv}, and S_{Iw} (See FIG. 3) like a hall element, and inputting the detected current value to the control device 200. In FIG. 3, in order to facilitate understanding, the current sensors S_{Iu}, S_{Iv}, and S_{Iw} are disposed outside the inverter 60.

The resolver 50 detects a rotational angle θ_{M} of the rotator of the motor 11, and outputs an angle signal corresponding to the detected angle, and is, for example, a variable-reluctance resolver having a detection circuit that detects a magnetic resistance change disposed near the magnetic rotator provided with a plurality of concavities and convexities in the circumferential direction at an equal interval.

The signal indicating the steering angle of the steering wheel 2 detected by the steering angle sensor 52 is input into the control device 200, and is converted into a turning angle 5 for the front wheels 10F, 10F.

Returning to FIG. 1, the steering wheel torque sensor 30 detects pinion torque applied to the pinion shaft 5, i.e., the steering wheel torque T, and for example, magnetic films are applied at two locations of the pinion shaft 5 in the axial direction so as to be aerotropic in opposite directions, and a detection coil is fitted to the surface of each magnetic film with a gap from the pinion shaft 5. The differential amplifier circuit 40 amplifies the difference in a change in magnetic permeability of two magnetostrictive films detected by the detection coil as a change in inductance, and inputs a signal indicating the steering wheel torque T to the control device 200.

The vehicle speed sensor 35 detects a vehicle speed VS (driving condition information) of the vehicle as the number of pulses per unit time, and outputs a signal indicating the vehicle speed VS.

As shown in FIGS. 1 and 2, provided on the upper surface of the steering wheel 2 are operation switches (operation units) 2aL and 2aR slidable in the vertical direction and disposed near respective right and left ends of a spoke running to a ring grip portions in the substantially horizontal direction with the steering wheel 2 being in a neutral condition. Switch signals (electric signals) from the operation switches 2aL and 2aR are input into a switch operation determining unit 290A (see FIG. 3) of the control device 200 to be discussed later.

The operation switches 2aL and 2aR shown in FIG. 2 are sliding switches that allow the driver to slide in the vertical direction through a finger, and when no operation force is applied, returns to a neutral point A by a built-in spring.

As shown in FIG. 2, the operation switches 2aL and 2aR are provided along the circumferential direction of the steering wheel 2 at symmetrical positions with respect to a direction in which the steering wheel 2 is directed to a going-straight direction, i.e., a neutral position direction as a symmetrical axis D_{N}. An angle αdeg of each neutral point A of each of the operation switches 2aL and 2aR relative to the horizontal axis L_{H} orthogonal to the symmetrical axis D_{N} is considered at the time of, for example, setting by an operation switch validity determining unit 295 (see FIG. 3) to be discussed later of a range Rθ_{H} of the steering angle θ_{H} that makes the operation of the operation switches 2aL and 2aR valid, i.e., setting of a determination value on whether or not the steering angle θ_{H} in the left direction or in the right direction is within the predetermined first threshold. The range Rθ_{H} of the valid steering angle θ_{H} is set as the absolute value of the steering angle θ_{H}, and is the same range of the steering angle θ_{H} in both right and left.

The operation switch 2aL corresponds to a “left operation unit” in claims, and the operation switch 2aR corresponds to a “right operation unit” in the claims. Moreover, a “range Rθ_{H} of an valid steering angle θ_{H}” corresponds to a “predetermined first threshold in a left or right direction of a steering angle of a steering wheel” in the claims.

When the operation switch 2aL is slid upwardly from the neutral point A by a distance equal to or greater than a predetermined amount, or when the operation switch 2aR is slid downwardly from the neutral point A by a distance equal to or greater than a predetermined amount, the operation switch 2aL or the operation switch 2aR is activated (ON state), and generates a current waveform (an additional current value waveform) of an additional current value I_{Ad} (see FIG. 3) for steering in the right direction by a predetermined amount. The signal in the ON state will be referred to as a “right-direction steering correction signal”.

Moreover, when the operation switch 2aL is slid downwardly from the neutral point A by a distance equal to or greater than a predetermined amount or when the operation switch 2aR is slid upwardly from the neutral point A by a distance equal to or greater than a predetermined amount, the operation switch 2aL or the operation switch 2aR is activated (ON state), and generates a current waveform of an additional current value I_{Ad} for steering in the left direction by a predetermined amount. This signal in this ON state is referred to as a “left-direction steering correction signal”.

When the operation switches 2aL and 2aR are in the neutral point A, both operation switches 2aL and 2aR are deactivated (OFF state).

It is easy for the switch operation determining unit 290A to determine whether or not the operation switches 2aL and 2aR are outputting signals that generate a current waveform of the additional current value I_{Ad} for steering in the right or left direction by a predetermined amount if the operation switches 2aL and 2aR employ circuit configurations in which the output signal by the operation switches 2aL and 2aR has positive or negative polarities.

According to this embodiment, the two operation switches 2aL and 2aR are provided but a configuration having either one of such switches may be employed.

<<Control Device>>

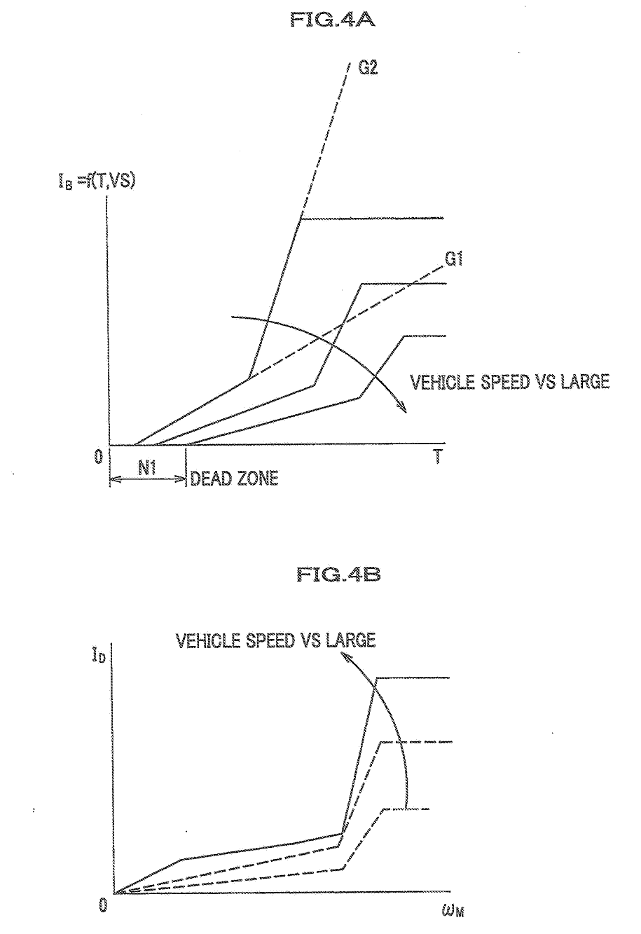

Next, with reference to FIG. 3, and FIGS. 1, 4 to 6 as needed, a configuration and a function of the control device 200A of the first embodiment will be explained. FIG. 4A is an explanatory diagram for a method of setting a base target current value using a base table by a base signal computing unit. FIG. 4B is an explanatory diagram for a method of setting a damper correction current value using a damper table by a damper correction signal computing unit.

The control device 200A is configured by a microcomputer having a CPU (Central Processing Unit), a ROM (Read Only Memory), a RAM (Random Access Memory), etc., and an interface circuit and a program stored in the ROM, and realizes functions shown in the functional block configuration diagram of FIG. 3.

The control device 200A of FIG. 3 includes a base signal computing unit 220, an inertia compensation signal computing unit 210, a damper correction signal computing unit 225, a q-axis PI control unit 240, a d-axis PI control unit 245, a two-axis three-phase converter unit 260, a PWM converter unit 262, a three-phase two-axis converter unit 265, an exciting current generating unit 275, and an additional current computing unit (additional current computing unit) 300A, etc.

<Base Signal Computing Unit 220>

The base signal computing unit 220 generates, based on a signal indicating the steering wheel torque T from the differential amplifier circuit 40 (see FIG. 1) and a signal indicating the vehicle speed VS from the vehicle speed sensor 35 (see FIG. 1), a base target current value I_{B} that is a reference target value to steering assist force output by the motor 11 (see FIG. 1). Generation of the base target current value I_{B} is carried out by referring to a base table 220a set in advance through a test measurement, etc., with the steering wheel torque T and the vehicle speed VS as keys.

FIG. 4A shows a function of the base target current value I_{B} stored in the base table 220a. FIGS. 4A and 4B show an example case in which the value of the steering wheel torque T is positive, but when the steering wheel torque T has a negative value, the value of the base target current value I_{B} becomes negative, and the band of a dead-zone N1 is also set in the negative side. When the steering wheel torque T of the steering in the right direction is positive (+) and the steering wheel torque T of the steering in the left direction is negative (−), in the following explanation, the difference in the steering wheel torque T between right and left is only a ± sign. Accordingly, the explanation will be representatively given of the positive side (the right side) and the explanation for the left side (the negative side) will be omitted accordingly.

The difference between the upper limit dead-zone torque and the lower limit dead-zone torque is also only a ± sign, and thus the explanation for the lower limit dead-zone torque will be omitted accordingly.

The steering angle θ_{H} to the left from the neutral state has a negative value and the steering angle to the right from the neutral state has a positive value in the following explanation.

With reference to FIG. 4A, when the explanation will be given of an example case in which the steering wheel torque T has a positive value, the base signal computing unit 220 has a feature of using the base table 220a, when the positive value of the steering wheel torque T is small, setting the dead-zone N1 in the positive side where the base target current value I_{B} is set to be zero, and when the value of the steering wheel torque T becomes equal to or greater than the uppermost value (dead-zone upper limit torque) of the positive value of the dead-zone N1, linearly increasing the base target current value I_{B} by a gain G1. Moreover, the base signal computing unit 220 also has a feature of increasing the output by a gain G2 at a predetermined steering wheel torque value, and when the steering wheel torque value further increases, saturating the output to a predetermined positive saturated value.

The dead-zone N1 in the positive side and the dead-zone N1 in the negative side are collectively referred to as a “dead-zone N1”.

In general, a vehicle has a different load of a road surface (road reaction force) depending on the running speed, and thus the value of the dead-zone upper limit torque, the gains G1 and G2, and the saturated value of the base target current value are adjusted based on the vehicle speed VS. The load becomes maximum at the time of static steering when the vehicle speed is zero, and becomes relatively little when the vehicle speed is medium and slow. Hence, the base signal computing unit 220 sets the gains (G1 and G2) and the absolute value of the saturated value to be small and the dead-zone upper limit torque to be large as the vehicle speed VS increases and becomes high, thereby expanding a manual steering range to properly give road information to the driver.

That is, depending on the increase of the vehicle speed VS, a sharp feeling of the steering wheel torque T is given to the driver. At this time, it is necessary to perform inertia compensation in the manual steering range.

<Damper Correction Signal Computing Unit 225>

Returning now to FIG. 3, the damper correction signal computing unit 225 is provided to realize a steering damper function which compensates the viscosity of the steering system and which corrects the convergence performance that decreases when the vehicle runs at a high speed. The damper correction signal computing unit 225 uses a damper table 225a to perform computation with reference to a rotational angular speed ω_{M} of the motor 11. FIG. 4B shows a function of a damper correction current value I_{D} stored in the damper table 225a. FIG. 4B shows a case in which the value of the rotational angular speed ω_{M} of the motor 11 is positive, but when the value of the rotational angular speed ω_{M} is negative, the value of the damper correction current value I_{D} also becomes negative. First, with reference to FIG. 4B, when the explanation will be given of the case in which the value of the rotational angular speed ω_{M} is positive, the damper correction signal computing unit 255 has a feature such that the more the rotational angular speed ω_{M} of the motor 11 increases, the more the damper correction current value I_{D} linearly increases, and the damper correction current value rapidly increases at a predetermined rotational angular speed ω_{M}, and becomes a predetermined positive saturated value depending on the vehicle speed VS.

Likewise, the damper correction signal computing unit 255 has a feature such that when the value of the rotational angular speed ω_{M} is negative, the more the rotational angular speed ω_{M} of the motor 11 increases in the negative value direction, the more the damper correction current value I_{D} linearly increases in the negative value direction, and the damper correction current value I_{D} rapidly increases at a predetermined rotational angular speed ω_{M} in the negative value direction, and becomes a predetermined negative saturated value depending on the vehicle speed VS.

The higher the value of the vehicle speed VS is, the more both gains and absolute value of the saturated value are increased, and the steering assist force output by the motor 11 is attenuated by causing a subtractor 251 to subtract the damper correction current value I_{D} from the base target current value I_{B} in accordance with the rotational angular speed of the motor 11, i.e., the steering angle speed.

In other words, when turning of the steering wheel increases, the value of a steering assist force current in the direction in which the turning of the steering wheel 2 increases to the motor 11 is decreased as the rotational speed of the steering wheel 2 becomes fast in order to make the steering feeling of the steering wheel 2 heavy so as to make the turning of the steering wheel 2 difficult. When the steering wheel 2 is returned, a current of the reaction force direction to the motor 11 relative to the returning operation is increased to make the returning of the steering wheel 2 uneasy. According to this steering damper effect, the convergence performance of the steering wheel 2 is improved, thereby stabilizing the turning motion characteristic of the vehicle.

<Subtractor 251>

Returning to FIG. 3 again, the subtractor 251 subtracts the damper correction current value I_{D} of the damper correction signal computing unit 225 from the base target current value I_{B} of the base signal computing unit 220, and inputs the subtraction result into an adder 250.

<Inertia Compensation Signal Computing Unit 210>

The inertia compensation signal computing unit 210 compensates an effect by inertia of the steering system, uses an inertia table 210a of the inertia compensation signal computing unit 210, refers to the steering wheel torque T, and calculates the above-explained inertia compensation current value I_{I}.

The inertia compensation signal computing unit 210 also compensates the reduction of the responsiveness of the motor 11 due to the inertia of the rotator. In other words, when the motor 11 changes the rotational direction from the positive direction to the negative direction or from the negative direction to the positive direction, the motor 11 attempts to maintain the state by inertia, and thus the rotational direction cannot be changed immediately. Hence, the inertia compensation signal computing unit 210 performs a control in such a way that the change in the rotational direction of the motor 11 matches the timing at which the rotational direction of the steering wheel 2 changes. The inertia compensation signal computing unit 210 improves the response delay of steering originating from the inertia and viscosity of the steering system in this manner, thereby providing a smooth steering feeling. Moreover, a sufficient characteristic in practice is given to a steering characteristic that varies depending on the vehicular characteristics, such as an FF (Front engine Front wheel drive) or an FR (Front engine Rear wheel drive) vehicle, an RV (Recreational vehicle), and a sedan, and vehicular conditions, such as a vehicle speed and a road condition.

<Adders 250 and 252, Subtractor 253, and q-Axis PI Control Unit 240>

The adder 250 adds the input from the subtractor 251 and the inertia compensation current value I_{I} from the inertia compensation signal computing unit 210. A q-axis target current value I_{TG1} that is an output signal by the adder 250 is a target signal of a q-axis current that defines the output torque of the motor 11, and is input into an adder 252.

Input into the adder 252 is the additional current value I_{Ad} to be discussed later from the additional current computing unit 300A, and a q-axis target current value Iq* that is an addition result of the additional current value I_{Ad} to the q-axis target current value I_{TG1} is input into a subtractor 253. As a result, the q-axis target current value I_{TG1} is added with the additional current value I_{Ad} with a predetermined current waveform by the adder 252, and input as the q-axis target current value Iq* into the subtractor 253.

Input into the subtractor 253 is a q-axis actual current value Iq from the three-phase two-axis converter unit 265, and a result of subtracting the q-axis actual current value Iq from the q-axis target current value Iq* is input into the q-axis PI control unit 240 as a deviation value ΔIq* that is a control signal.

The q-axis PI control unit 240 performs a feedback control of a P (proportional) control and an I (integral) control so as to decrease the deviation value ΔIq* to obtain a q-axis target voltage value Vq* that is a q-axis target signal, and inputs such a signal into the two-axis three-phase converter unit 260.

<Exciting Current Generating Unit 275, Subtractor 254, and d-Axis PI Control Unit 245>

The exciting current generating unit 275 generates a target signal that is “zero” to a d-axis target current value Id* of the motor 11, but performs a field weakening control by substantially equalizing the d-axis target current value Id* and the q-axis target current value Iq* as needed.

Input into the subtractor 254 is a d-axis actual current value Id from the three-phase two-axis converter unit 265, and a result of subtracting the d-axis actual current value Id from the d-axis target current value Id* is input into the d-axis PI control unit 245 as a deviation value ΔId* that is a control signal.

The d-axis PI control unit 245 performs a PI feedback control of a P (proportional) control and an I (integral) control so as to decrease the deviation value ΔId* to obtain a d-axis target voltage value Vd* that is a d-axis target signal, and inputs such a signal into the two-axis three-phase converter unit 260.

<Two-Axis Three-Phase Converter Unit 260 and PWM Converter Unit 262>

The two-axis three-phase converter unit 260 converts two-axis signals that are the d-axis target voltage value Vd* and the q-axis target voltage value Vq* into three-phase signals that are Uᵤ*, Uᵥ*, and U_{w}* using the rotational angle θ_{M}. The PWM converter unit 262 generates DUTY signals (in FIG. 3, indicated as “DUTYᵤ”, “DUTYᵥ”, and “DUTY_{w}”) that are ON/OFF signals (PWM (Pulse Width Modulation) signals) with pulse widths in accordance with respective levels of the three-phase signals Uᵤ*, Uᵥ*, and U_{w}*.

Note that input into the two-axis three-phase converter unit 260 and the PWM converter unit 262 is a signal indicating the rotational angle θ_{M} of the motor 11 from the resolver 50, and an arithmetic processing and a control depending on the rotational angle θ_{M} of the rotator are performed.

<Three-Phase Two-Axis Converter Unit 265>

The three-phase two-axis converter unit 265 converts the three-phase actual current values Iu, Iv, and Iw of the motor 11 detected by the current sensors S_{Iu}, S_{Iv}, and S_{Iw} of the inverter 60 into the d-axis actual current value Id, and the q-axis actual current value Iq in a d-q coordinate system using the rotational angle θ_{M}, inputs the d-axis actual current value Id into a subtractor 254, and inputs the q-axis actual current value Iq into the subtractor 253.

The q-axis actual current value Iq is proportional to the generated torque by the motor 11, and the d-axis actual current value Id is proportional to the exciting current.

<Rotational Angular Speed Computing Unit 270>

A rotational angular speed computing unit 270 performs temporal differentiation on the input rotational angle θ_{M} to calculate the rotational angular speed ω_{M}, and inputs the calculated rotational angular speed into the damper correction signal computing unit 225.

<Additional Current Computing Unit 300A and Adder 252>

Next, with reference to FIGS. 3, 5A, 5B and 6, an explanation will be given of the additional current computing unit 300A that is a characteristic configuration of this embodiment.

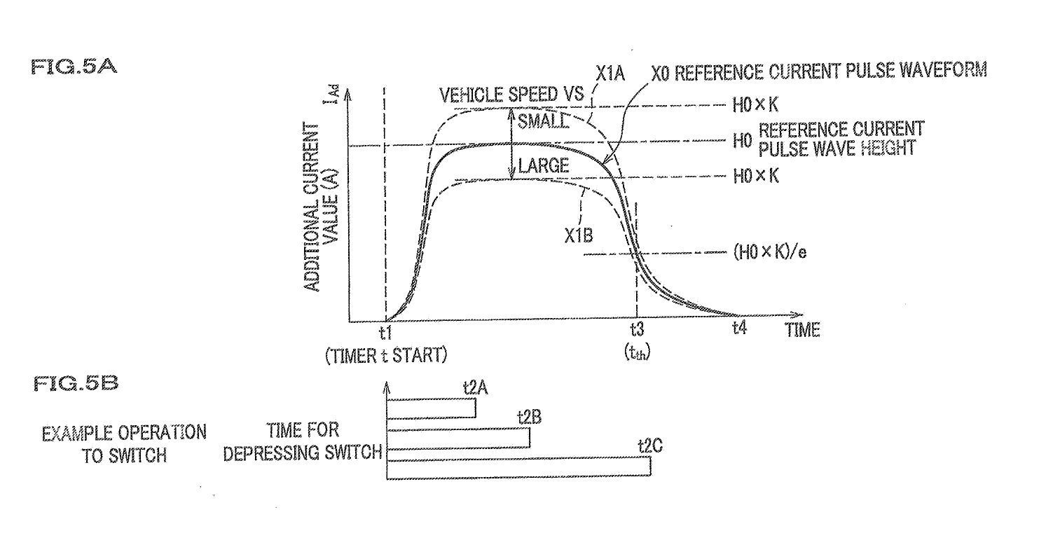

FIGS. 5A and 5B are explanatory diagrams for generation of an additional current value waveform by the additional current computing unit shown in FIG. 3. FIG. 5A is an explanatory diagram for a change in the output additional current value as time advances, and FIG. 5B is an explanatory diagram that the time length of the ON state of the operation switch provided on the steering wheel does not affect the additional current value waveform to be output.

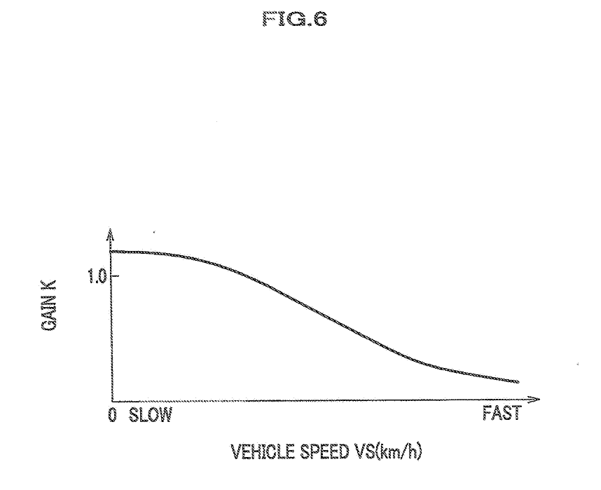

FIGS. 5A and 5B show an illustrative current waveform when the additional current value I_{Ad} is positive, and the current waveform when the additional current value I_{Ad} is negative is an inverted waveform downwardly in a line-symmetric manner relative to the time axis. FIG. 6 is an explanatory diagram for a gain K that sets the wave height of the additional current value in the gain setting unit shown in FIG. 3 in accordance with the vehicle speed VS.

As shown in FIG. 3, the additional current computing unit 300A includes the switch operation determining unit 290A, a reference waveform setting unit 291A, a gain setting unit 292A, the operation switch validity determining unit 295, an output waveform computing unit 297A, an additional current-output control unit 298, and an output waveform monitoring unit 299. The additional current value I_{Ad} output by the additional current-output control unit 298 is input into the adder 252. As explained above, the adder 252 adds the q-axis target current value I_{TG1} output by the adder 250 and the additional current value I_{Ad}, and the q-axis target current value Iq* is output into the subtractor 253.

A configuration and a function of the additional current computing unit 300A will be explained in more detail.

The control process by the additional current computing unit 300A is executed by a CPU at a certain process cycle, e.g., at a cycle of 10 msec, like the base signal computing unit 220, the inertia compensation signal computing unit 210, the damper correction signal computing unit 225, the q-axis PI control unit 240, the d-axis PI control unit 245, the two-axis three-phase converter unit 260, the PWM converter unit 262, the three-phase two-axis converter unit 265, and the exciting current generating unit 275, etc.

<Switch Operation Determining Unit 290A>

Input into the switch operation determining unit 290A are the switch signals from the operation switches 2aL and 2aR and a signal indicating a determination result from the operation switch validity determining unit 295. When the signal indicating the determination result from the operation switch validity determining unit 295 indicates the validity, if the right-direction steering correction signal or the left-direction steering correction signal is input from the operation switch 2aL or 2aR, the switch operation determining unit 290A inputs a reference waveform output signal to the reference waveform setting unit 291A, inputs a positive (+) signal to the output waveform computing unit 297A with respect to the right-direction steering correction signal, and inputs a negative (−) signal thereto with respect to the left-direction steering correction signal.

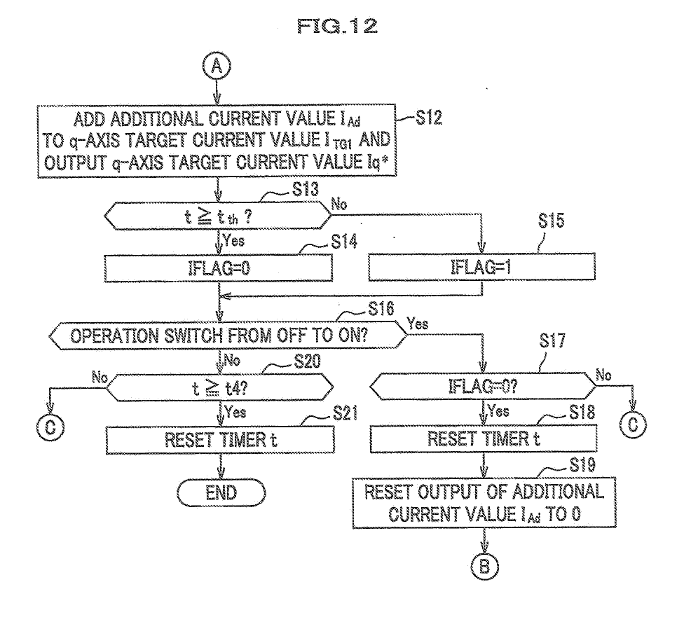

When a predetermined threshold time tₜₕ has elapsed after the switch operation determining unit 290A receives the switch signals from the operation switches 2aL and 2aR, the switch operation determining unit 290A accepts new inputting of the switch signals from the operation switches 2aL and 2aR. The detail of this function will be explained in detail later with reference to the flowchart of FIG. 12.

<Reference Waveform Setting Unit 291A>

The reference waveform setting unit 291A inputs a reference current pulse waveform X0 shown in FIG. 5A into the output waveform computing unit 297A when the reference waveform output signal is input from the switch operation determining unit 290A. The reference current pulse waveform X0 is a current waveform set in advance by way of experiment for the reference current pulse wave height of H0, and the data of such a reference current pulse waveform X0 is stored in the ROM in advance, and is read and used.

<Gain Setting Unit 292A>

The gain setting unit 292A refers to gain characteristic data shown in FIG. 6 and stored in the ROM in advance, obtains the value of the gain K in accordance with the vehicle speed VS, and inputs the obtained value into the output waveform computing unit 297A.

The gain characteristic data has a value of the gain K equal to or greater than 1.0 when the vehicle speed VS is slow as shown in FIG. 6, but as the vehicle speed VS increases, the reduction level of the gain K gradually becomes sharp, which substantially linearly decreases, and has a substantially saturated value of the gain K at equal to or faster than the predetermined vehicle speed VS.

The gain characteristic data is set in advance depending on the current-output characteristic of the motor 11 used for the electric power steering device 100, a turning load depending on the vehicle speed VS when the vehicle is turned, and the setting of the target change level of the turning angle for turning the front wheels 10F, 10F (see FIG. 1) by the current waveform of an additional current value I_{Ad} depending on the vehicle speed.

First of all, the target change level of the turning angle δ by the current waveform of an additional current value I_{Ad} is set to be large when the vehicle speed VS is slow, and is set to be small when the vehicle speed VS is fast. For example, when the vehicle speed VS is equal to or faster than substantially 100 km/h, the target change level of the turning angle δ is set to be substantially 1 degree, when the vehicle speed VS is equal to or slower than substantially 40 km/h, the target change level of the turning angle δ is set to be substantially 3 degrees, and when the vehicle speed VS is between 40 to 100 km/h, the target change level is set so as to obtain the turning angle δ linearly interpolated. In the following explanation, the “target change level of the turning angle δ” is referred to as a “turning-angle target change level”.

In addition, the gain characteristic data is set in consideration of the current-output characteristic of the motor 11 and the turning load of the front wheels 10F, 10F from the road surface through a test by an actual vehicle and a simulation to obtain the above-explained turning-angle target change level.

<Operation Switch Validity Determining Unit 295>

The operation switch validity determining unit 295 receives the input of the signal indicating the steering angle θ_{H} from the steering angle sensor 52 (see FIG. 1), determines whether or not the operation given for the operation switches 2aL and 2aR is within the range Rθ_{H} of the valid steering angle θ_{H}, and inputs the determination result in the switch operation determining unit 290A.

The range Rθ_{H} of the steering angle θ_{H} where the operation for the operation switches 2aL and 2aR is valid is a range where the driver can easily operate the operation switches 2aL and 2aR, and is substantially −30 degrees≦θ_{H}≦+30 degrees.

<Output Waveform Computing Unit 297A>

The output waveform computing unit 297A receives the inputting of the reference current pulse waveform X0 (see FIG. 5A) from the reference waveform setting unit 291A, multiplies the reference current pulse waveform X0 by a positive/negative (±) sign in accordance with the positive/negative (±) signal input from the switch operation determining unit 290A, and also multiplies by the gain K input from the gain setting unit 292A to generate a current waveform of the additional current value I_{Ad}, and inputs the generated current waveform in the additional current-output control unit 298.

As shown in FIG. 6, since the value of the gain K changes depending on the value of the vehicle speed VS, the smaller the value of the vehicle speed VS is, the larger the value of the gain K becomes and a current waveform of the additional current value I_{Ad} indicated by a reference sign X1A is obtained. On the other hand, the larger the value of the vehicle speed VS is, the smaller the value of the gain K becomes and a current waveform of the additional current value I_{Ad} indicated by a reference sign X1B is obtained.

The current waveform of the additional current value I_{Ad} indicated by the reference sign X0 is obtained when the gain K=1.0. The current waveform of the additional current value I_{Ad} indicated by the reference sign X1B is obtained when the gain K<1.0. The current waveform of the additional current value I_{Ad} indicated by the reference sign X1A is obtained when the gain K>1.0.

The reason why the current waveform of the additional current value I_{Ad} is, as shown in FIG. 5A, not a rectangular wave but rises and falls gently is that when the activation of the motor 11 immediately starts and stops upon operation of the operation switches 2aL and 2aR given by the driver, the motion of the steering wheel 2 becomes sudden, e.g., one like receiving a sudden kick-back from the road surface, and becomes absolutely different motion from the driver's steering correction operation, so that the same motion as the operation of the steering correction performed by the driver while viewing the front without thought can be obtained.

Note that the transfer lag from the control system (the control device 200) and the mechanical system and the turning-angle target change level are small, and thus the current waveform of the additional current value I_{Ad} may be a rectangular wave.

In FIG. 5A, a time t1 indicates a timing at which the driver operates either one of the operation switches 2aL and 2aR and such a switch becomes an ON state, and a time t4 indicates a timing at which the current waveform of the additional current value I_{Ad} that has started rising at the time t1 falls down to 0 (zero).

The time t1 corresponds to a timing of starting a timer t in step S04 in the flowchart of FIG. 11 to be discussed later. Moreover, a time t3 to be discussed later corresponds to a threshold time tₜₕ in step S13 in the flowchart of FIG. 12.

The current waveform of the additional current value I_{Ad} depending on the value of the vehicle speed VS is obtained by multiplying the reference current pulse waveform X0 by the positive/negative (±) sign and the gain K, and is a current waveform of the additional current value I_{Ad} for a predetermined time length from the time t1 to the time t4. The time t3 (=tₜₕ) shown in FIG. 5A is, when it reaches the predetermined threshold time tₜₕ after the switch operation determining unit 290A receives the switch signals from the operation switches 2aL and 2aR, a time of receiving a new input of the switch signals from the operation switches 2aL and 2aR. For example, a time t3(tₜₕ) is a time when the current waveform of the additional current value I_{Ad} becomes a value of, for example, (H0×K)/e, and the time t3 is uniquely set regardless of the value of the gain K.

H0 indicates the wave height of the reference current pulse, and e is a bottom value of a natural logarithm.

Corresponding to the time axis in FIG. 5A, the horizontal axis of FIG. 5B is for explaining that when the ON states of the operation switches 2aL and 2aR start from the time t1 but the times when the ON state ends (the operation time) differ like t2A, t2B, and t2C, the switch operation determining unit 290A generates only one current waveform of the additional current value I_{Ad} from the time t1 to the time t4.

<Additional Current-Output Control Unit 298>

The additional current-output control unit 298 receives the input of the current waveform of the additional current value I_{Ad} from the output waveform computing unit 297A, temporally holds data on the current waveform, performs sampling of the additional current value I_{Ad} from the current waveform temporally held for a certain time step, e.g., a time step of 10 msec, and outputs the additional current value I_{Ad} for each time step in accordance with the current waveform of the additional current value I_{Ad} to the adder 252.

The additional current-output control unit 298 terminates outputting of the additional current value by making the currently output additional current value I_{Ad} to be 0 (zero) when a control signal Sc is input from the switch operation determining unit 290A, and clears the data on the current waveform temporally held.

<Output Waveform Monitoring Unit 299>

The output waveform monitoring unit 299 calculates, when the output waveform computing unit 297A generates the current waveform of the additional current value I_{Ad} as shown in FIGS. 5A and 5B, the threshold time tₜₕ that is a timing at which the output current of the additional current value I_{Ad} reaches the wave height (H0×K) and starts falling after being output and the wave height becomes lower than the value of (H0×K)/e, and inputs the calculated threshold time tₜₕ into the switch operation determining unit 290A. According to this embodiment, as explained above, the threshold time tₜₕ is a fixed value, and a configuration may be employed in which the switch operation determining unit 290A has the value of the threshold time tₜₕ that is the fixed value without obtaining the data on the current waveform of the additional current value I_{Ad} from the output waveform computing unit 297A.

The setting of the threshold time tₜₕ is made based on a standpoint that the output of the current waveform of the additional current value I_{Ad} becomes a falling state and can be deemed as being attenuated to the wave height where a predetermined steering correction operation substantially completes, and a standpoint that even if the additional current value I_{Ad} currently output is set to be 0 (zero) to terminate the output, the driver does not feel large strangeness, and is not limited to the timing of becoming lower than the value of (H0×K)/e.

<Steering Angle Frequency, Operation Easiness of Operation Switch and Steering Correction Force>

Next, with reference to FIGS. 7 to 10B, and FIG. 1 as needed, an explanation will be given of a steering angle frequency, the operation easiness of the operation switches 2aL and 2aR (see FIG. 1), and steering correction force.

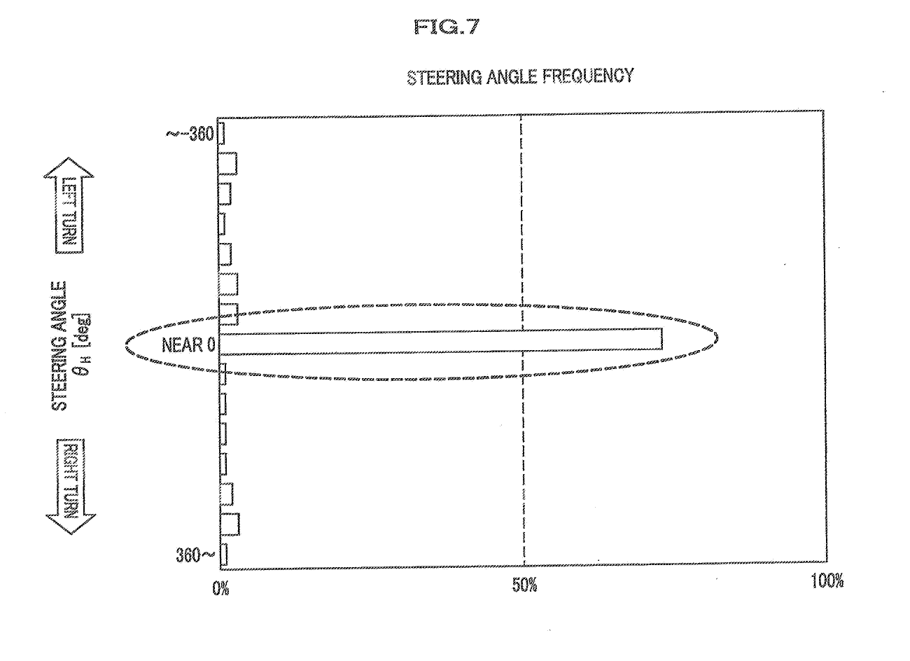

FIG. 7 is an explanatory diagram for a frequency distribution of the steering angle of the steering wheel when an actual vehicle is running. In FIG. 7, the vertical axis indicates a bar graph with a predetermined width of the steering angle θ_{H} which is expressed up to 360 degrees in the right and left, and the total frequency is set to be 100%. The horizontal axis indicates a relative frequency in a percentage. When predetermined driving pattern models including a street driving and a highway driving were set on a test course to carry out driving tests of an actual vehicle, and data on the occurrence frequency of the steering angle θ_{H} of the steering wheel 2 (see FIG. 1) was obtained, as shown in FIG. 7, it becomes clear that the occurrence frequency of the steering angle θ_{H} within a predetermined range, roughly from −15 to +15 degrees near the neutral position (indicated as “near 0” in FIG. 7) of the steering angle θ_{H} was overwhelmingly high, and the occurrence frequency of the right steering angle and that of the left steering angle beyond such a range were remarkably small.

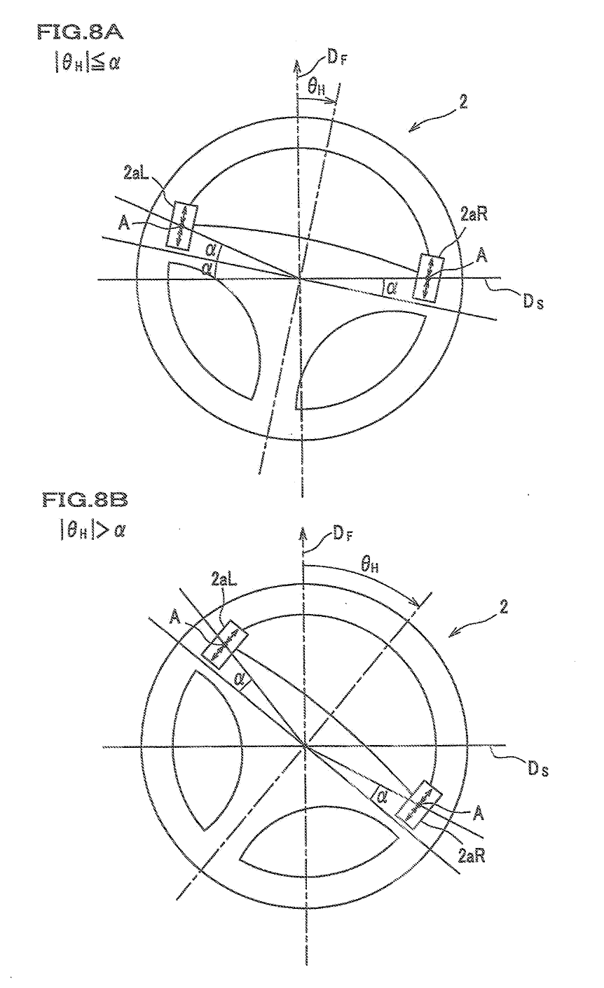

Hence, according to this embodiment, with reference to FIGS. 7, 8A, 8B, and tables 1 and 2, an explanation in detail will be given of a first or second method to be discussed later of causing the operation switch validity determining unit 295 and the switch operation determining unit 290A to make the steering correction operation through the operation of the operation switches 2aL and 2aR valid when the steering angle θ_{H} is turned to the right and left, i.e., the steering angle is within the predetermined range Rθ_{H} e.g., roughly from −30 to +30 degrees set as a wide range near the neutral position of the steering angle θ_{H} with such a neutral position being as a center while taking a margin relative to the predetermined range near the neutral position of the steering angle θ_{H} shown in FIG. 7. When it is determined that the operation to the operation switches 2aL and 2aR is valid, the additional current value I_{Ad} is output.

The example values of ±30 degrees setting the range Rθ_{H} of the steering angle θ_{H} that makes the operation to the operation switches 2aL and 2aR valid is desirably set with reference to an angle α degrees of respective neutral points A of the operation switches 2aL and 2aR relative to, for example, the above-explained horizontal axis L_{H} (see FIG. 2). FIGS. 8A and 8B are explanatory diagrams for the method of setting the range Rθ_{H} of the steering angle θ_{H} that makes the operation of the operation switches 2aL and 2aR valid. FIG. 8A is an explanatory diagram when the steering angle θ_{H} is within the predetermined range Rθ_{H}, and FIG. 8B is an explanatory diagram when the steering angle θ_{H} is out of the predetermined range Rθ_{H}. FIGS. 8A and 8B explain how to set the range Rθ_{H} of the steering angle θ_{H} where the operation to the operation switches 2aL and 2aR is valid in an example case in which the steering wheel 2 is turned to the right.

As shown in FIG. 8A, when |θ_{H}|≦α degrees, the neutral point A of the operation switch 2aR is a position D_{S} at maximum in the vehicle body lateral direction, or is above that position. Hence, the upward (counterclockwise direction) sliding direction of the operation switch 2aR can be clearly recognized by the driver as a steering correction operation to the left, or the downward (clockwise direction) sliding direction of the operation switch 2aR can be also intuitively and clearly recognized by the driver as a steering correction operation to the right.

The neutral point A of the operation switch 2aL is an upper position of 2α degrees at maximum relative to the position D_{S} in the vehicle body lateral direction, or is below that position. Hence, the upward (clockwise direction) sliding direction of the operation switch 2aL can be still sufficiently intuitively and clearly recognized by the driver as a steering correction operation to the right, or the downward (counterclockwise direction) sliding direction of the operation switch 2aL can be still sufficiently intuitively and clearly recognized by the driver as a steering correction operation to the left.

In contrast, as shown in FIG. 8B, when |θ_{H}|>α degrees, the neutral point A of the operation switch 2aR is below the position D_{S} in the vehicle body lateral direction at maximum. Hence, the upward (counterclockwise direction) sliding direction of the operation switch 2aR indicates the right direction to the driver, and it is difficult for the driver to intuitively recognize such a sliding as a steering correction operation to the left, or the downward (clockwise direction) sliding direction of the operation switch 2aR indicates the left direction to the driver, and it is difficult for the driver to sufficiently intuitively recognize such a sliding as a steering correction operation to the right.

However, from the standpoint of the operation switch 2aL, not the operation switch 2aR, the neutral point A of the operation switch 2aL is located at a position of equal to or greater than 2α degrees at maximum above the position D_{S} in the vehicle body lateral direction within the range Rθ_{H} of the valid steering angle θ_{H}, but is located at the left from a vehicle body front direction D_{F}. Hence, the upward (clockwise direction) sliding direction of the operation switch 2aL can be intuitively and clearly recognized by the driver as a steering correction operation to the right, or the downward (counterclockwise direction) sliding direction of the operation switch 2aL can be intuitively and clearly recognized by the driver as a steering correction operation to the left.

Hence, there are following two possible methods that control outputting/non-outputting of the additional current value I_{Ad} upon determination on whether or not the operation given to the operation switches 2aL and 2aR is valid through a combination of both functions of the operation switch validity determining unit 295 and the switch operation determining unit 290A in steps S03, S04, and S07 in the flowchart of FIG. 11 to be discussed later, and either one method can be selected.

The first method is, as shown in table 1, when the steering angle θ_{H} is out of the predetermined range Rθ_{H}, i.e., exceeds a predetermined first threshold, the operation switch validity determining unit 295 inputs a signal indicating that the steering angle is out of the valid range Rθ_{H} into the switch operation determining unit 290A, and the switch operation determining unit 290A detects the ON states of the operation switches 2aL and 2aR, to deem that there is an incorrect operation (there is no intension for operation) relative to the detection of the ON states of both operation switches 2aL and 2aR, and not to output the additional current value I_{Ad}. Next, in the first method, when the steering angle θ_{H} is within the predetermined range Rθ_{H}, if the operation switch validity determining unit 295 inputs the signal indicating that the steering angle is within the valid range Rθ_{H} into the switch operation determining unit 290A and the switch operation determining unit 290A detects the ON states of the operation switches 2aL and 2aR, it is deemed that the driver has an intension for operation relative to the detection of the ON states of both operation switches 2aL and 2aR, and the additional current value I_{Ad} is output.

In table 1, a circular mark indicates the validity of the operation switches 2aL and 2aR, and a cross mark indicates the invalidity of the operation switches 2aL and 2aR.

TABLE 1

| | Steering angle θ_{H} (Unit: Degrees) | | |
|---|---|---|---|
| | Out of | Within | Out of |
| | predetermined | predetermined | predetermined |
| | range Rθ_{H} | range Rθ_{H} | range Rθ_{H} |
| | (θ_{H} < −α) | (−α ≦ θ_{H} ≦ +α) | (+α < θ_{H}) |
| Operation | x | ∘ | x |
| switch 2aL | | | |
| Operation | x | ∘ | x |
| switch 2aR | | | |

A second method is, as shown in table 2, when, for example, the steering angle θ_{H} is out of the predetermined range Rθ_{H}, i.e., exceeds the predetermined first threshold, the operation switch validity determining unit 295 inputs the signal indicating that the steering angle is out of the valid range Rθ_{H} into the switch operation determining unit 290A in a range where the steering angle θ_{H} satisfies +α degrees<θ_{H}≦+90 degrees to the right (the predetermined second threshold of the steering angle of the steering wheel to the left or to the right), and the ON state of the operation switch 2aR is detected, not to output the additional current value I_{Ad} corresponding to the detection of the ON state of the operation switch 2aR, i.e., to make the operation to the operation switch 2aR invalid. At this time, when the switch operation determining unit 290A detects the ON state of the operation switch 2aL, the additional current value I_{Ad} corresponding to the detection of the ON state of the operation switch 2aL is output. That is, the operation to the operation switch 2aL is made valid.

Conversely, when, for example, the steering angle θ_{H} is out of the predetermined range Rθ_{H}, the operation switch validity determining unit 295 inputs the signal indicating that the steering angle is out of the effective range Rθ_{H} into the switch operation determining unit 290A within a range where the steering angle θ_{H} satisfies a condition −90 degrees≦θ_{H}<−α degrees to the left, and the switch operation determining unit 290A detects the ON state of the operation switch 2aL, the additional current value I_{Ad} corresponding to the detection of the ON state of the operation switch 2aL is not output, i.e., the operation to the operation switch 2aL is made invalid. At this time, when the switch operation determining unit 290A detects the ON state of the operation switch 2aR, the additional current value I_{Ad} corresponding to the detection of the ON state of the operation switch 2aR is output. That is, the operation to the operation switch 2aR is made invalid.

In table 2, a circular mark indicates the validity of the operation switches 2aL and 2aR, and a cross mark indicates the invalidity of the operation switches 2aL and 2aR.

TABLE 2

| | Steering angle θ_{H} (Unit: Degrees) | | | | |
|---|---|---|---|---|---|
| | Out of | Out of | Within | Out of | Out of |
| | predetermined | predetermined | predetermined | predetermined | predetermined |
| | range Rθ_{H} | range Rθ_{H} | range Rθ_{H} | range Rθ_{H} | range Rθ_{H} |
| | (θ_{H} < −90) | (−90 ≦ θ_{H} < −α) | (−α ≦ θ_{H} ≦ +α) | (+α < θ_{H} ≦ 90) | (+90 < θ_{H}) |
| Operation | x | x | ∘ | ∘ | x |
| switch 2aL | | | | | |
| Operation | x | ∘ | ∘ | x | x |
| switch 2aR | | | | | |

According to the second method, when the steering angle θ_{H} is within the predetermined range Rθ_{H}, if the operation switch validity determining unit 295 inputs a signal indicating that the steering angle is within the effective range Rθ_{H} into the switch operation determining unit 290A and the switch operation determining unit 290A detects the ON states of the operation switches 2aL and 2aR, it is deemed that the driver intends to operate both switches relative to the detection of the ON states of both operation switches 2aL and 2aR, and the additional current value I_{Ad} is output, i.e., operation of both switches are validated. Moreover, when the steering angle θ_{H} satisfies a condition that θ_{H}<−90 degrees and +90 degrees<θ_{H}, it is determined that the driver has no intension to operate the operation switches relative to the detection of the ON states of both operation switches 2aL and 2aR, and no additional current value I_{Ad} is output. That is, detection of the ON states of both operation switches 2aL and 2aR is invalidated.

The predetermined first threshold that sets the predetermined range Rθ_{H} and the predetermined second threshold larger than the predetermined first threshold are stored in the operation switch validity determining unit 295 in advance.

Furthermore, according to the above-explained first and second methods, when the steering angle θ_{H} is obtained which makes the operation switch validity determining unit 295 to determine that the operation to the operation switch 2aL and/or 2aR is invalid, the operation switch 2aL and/or 2aR determined as invalid may be locked so as not to be slidable, an audible alarm indicating that such an operation is invalid may be output at the time of operation, an illuminator built in or provided near the operation switches 2aL and 2aR may change the illumination color (e.g., from green to red), the illumination intensity of the illuminator may be changed (e.g., the brightness is increased), or a message may be displayed on the display unit of an instrument panel in order to cause the driver to recognize the invalidity of the operation to the operation switch 2aL and/or 2aR.

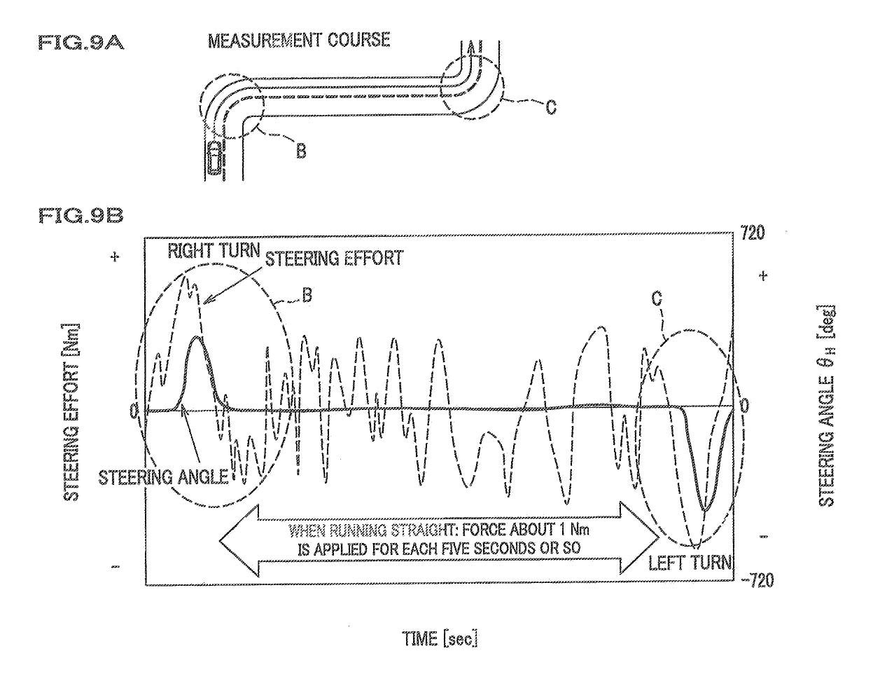

FIGS. 9A and 9B are explanatory diagrams for transitions of a steering angle and a steering effort as time advances when a vehicle runs at a slow speed. FIG. 9A is an explanatory diagram for a measurement course, and FIG. 9B is an explanatory diagram for transitions of a steering angle and a steering effort as time advances when the vehicle runs the measurement course shown in FIG. 9A.

FIG. 9A shows a case in which the vehicle turns to the right at a corner indicated as B in FIG. 9A, runs a straight course, and turns to the left at a corner indicated as C in the figure. With respect to this driving, the transition of the steering angle θ_{H} (unit: degree) as time advances is indicated by a solid line in FIG. 9B, and the transition of the steering effort (unit: Nm) by the driver as time advances is indicated by a dashed line. As is clear from FIG. 9B, in the straight course between the corners B and C, the driver performs steering correction operations to the right and left for a cycle of substantially each five seconds, and the steering effort at that time is substantially 1 to 2 Nm to the right and left (indicated as “substantially 1 Nm” in the figure).

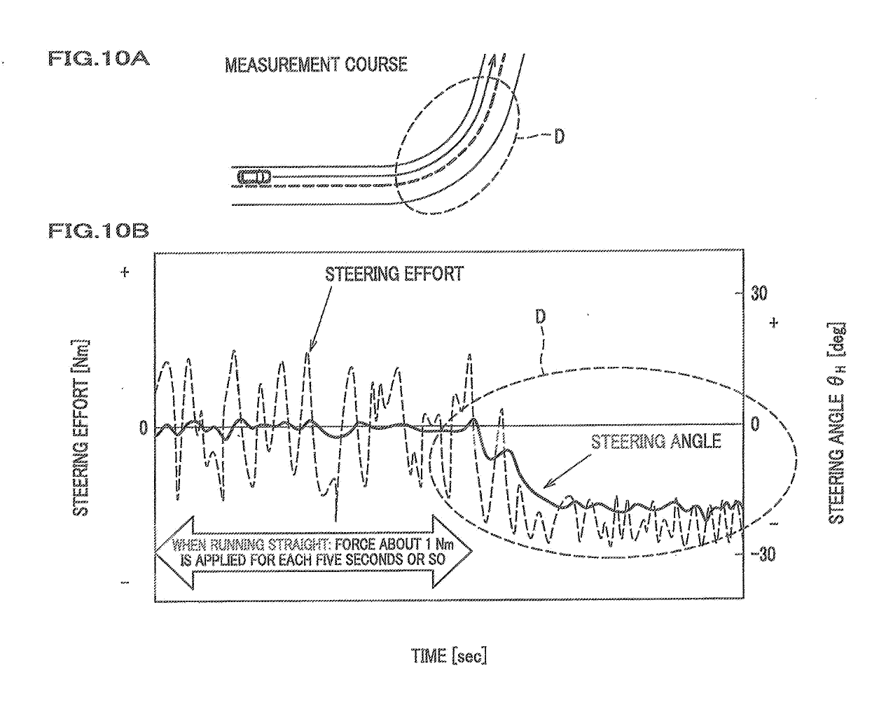

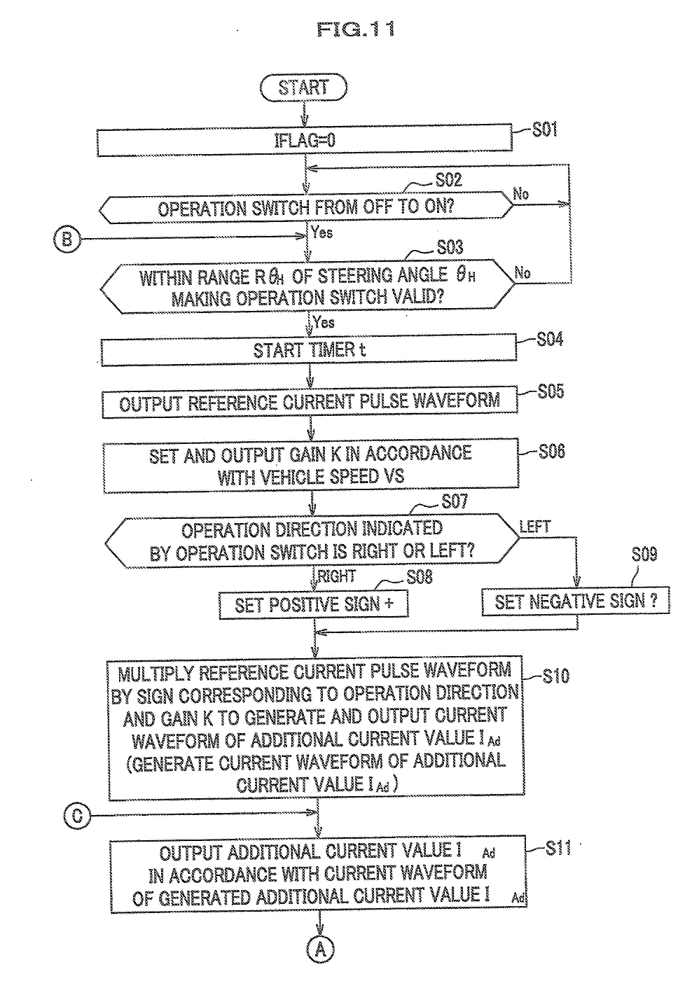

FIGS. 10A and 10B are explanatory diagrams for transitions of a steering angle and a steering effort as time advances when the vehicle runs at a fast speed. FIG. 10A is an explanatory diagram for a measurement course, and FIG. 10B is an explanatory diagram for transitions of the steering angle and the steering effort as time advances when the vehicle runs the measurement course show in FIG. 10A.

FIG. 10A shows a case in which the vehicle runs a straight course, turns to the left at a mild corner indicated as D, and then runs straight. With respect to this driving, the transition of the steering angle θ_{H} (unit: degree) as time advances is indicated by a solid line in FIG. 10B, and the transition of the steering effort (unit: Nm) as time advances by the driver is indicated as a dashed line. As is clear from FIG. 10B, before entering the corner D, the driver performs steering correction operations to the right and left for a cycle of substantially each five seconds while running the straight course, and the steering effort at that time is substantially 1 to 2 Nm (indicated as “substantially 1 Nm” in the figure). Moreover, it becomes clear that the range of the steering angle applied at the mild corner on a highway is normally within a range of substantially −15 to +15 degrees, a time of steering correction operation during turning is several seconds which is shorter than the substantially five seconds to the right and left while the vehicle runs straight and which is substantially half of that time, and the steering effort for this steering correction operation is substantially 1 Nm which is small.

Hence, according to this embodiment, the above-explained threshold time tₜₕ is set to be, for example, substantially two seconds, and the reference current pulse waveform X0 in FIG. 5A and the gain K in FIG. 6 are set in such a way that the current waveform of the additional current value I_{Ad} is obtained which realizes the turning-angle target change level of the front wheels 10F, 10F (see FIG. 1) that is, for example, substantially 2 degrees in a steering correction operation at a slow speed, e.g., substantially 40 km/h, and the current waveform of the additional current value I_{Ad} is obtained which realizes the turning-angle target change level of the front wheels 10F, 10F that is, for example, substantially 0.5 degrees smaller than that of the slow speed driving in a steering correction operation at a fast speed, e.g., substantially 100 km/h.

Depending on the grade of a vehicle, in the case of the vehicle tested as shown in FIGS. 9A to 10B, it is desirable that the current waveform of the additional current value I_{Ad} is obtained which ensures the steering effort of substantially 2 Nm at a slow speed, substantially 1 Nm for a steering correction operation at a fast speed.

<Generation and Output Control of Additional Current by Additional Current Computing Unit 300A>

Next, with reference to FIGS. 11 and 12, and FIGS. 3 and 5 as needed, an explanation will be given of an output control of the additional current value I_{Ad} by the additional current computing unit 300A. FIGS. 11 and 12 are flowcharts showing a flow of a generation and an output control of the additional current value waveform by the additional current computing unit 300A shown in FIG. 3.

First, the switch operation determining unit 290A (see FIG. 3) resets IFLAG=0 in step S01. IFLAG is a flag for a determination whether or not it is fine to output the additional current value I_{Ad} when the switch operation determining unit 290A detects the ON state of either one of the operation switches 2aL and 2aR (see FIG. 3), outputs the additional current value I_{Ad}, and detects the next ON state of either one of the operation switches 2aL and 2aR. When IFLAG=0, it indicates that the additional current value I_{Ad} can be output, and when IFLAG=1, it indicates that the additional current value I_{Ad} should not be output.

The switch operation determining unit 290A checks in step S02 whether or not the right-direction steering correction signal or the left-direction steering correction signal is received from at least either one of the operation switches 2aL and 2aR (OPERATION SWITCH CHANGED FROM OFF TO ON?). When the right-direction or left-direction steering correction signal is received (step S02: YES), the process progresses to step S03, and when no signal is received (step S02: NO), the process returns to the step S02.

The switch operation determining unit 290A checks in the step S03 whether or not the steering angle θ_{H} is within the range Rθ_{H} that makes at least either one of the operation switches 2aL and 2aR valid. More specifically, the switch operation determining unit 290A determines whether or not receiving a signal indicating that the present steering angle θ_{H} is within the range Rθ_{H} where the operation of at least either one of the operation switches 2aL and 2aR is valid from the operation switch validity determining unit 295 (see FIG. 3). When the steering angle θ_{H} is within the range where the operation of at least either one of the operation switches 2aL and 2aR is valid (step S03: YES), the process progresses to step S04, and when the steering angle is out of such a range (step S03: NO), the process returns to the step S02.

The switch operation determining unit 290A starts the time t and inputs the reference waveform output signal into the reference waveform setting unit 291A in the step S04. Upon reception of the reference waveform output signal from the switch operation determining unit 290A, the reference waveform setting unit 291A (see FIG. 3) outputs the reference current pulse waveform X0 (see FIGS. 5A and 5B) into the output waveform computing unit 297A (see FIG. 3) in step S05. When receiving no reference waveform output signal from the switch operation determining unit 290A, the reference waveform setting unit 291A outputs 0 (zero) signal to the output waveform computing unit 297A.

The gain setting unit 292A (see FIG. 3) refers to the gain characteristic data shown in FIG. 6, sets the gain K in accordance with the vehicle speed VS, and outputs the set gain to the output waveform computing unit 297A in step S06.

The switch operation determining unit 290A determines in step S07 whether the operation direction indicated by the operated operation switches 2aL and 2aR is right or left. When the operation direction is right, i.e., in the case of the right-direction steering correction signal (RIGHT), the process progresses to step S08, the switch operation determining unit 290A sets a positive sign +, and outputs the set sign to the output waveform computing unit 297A. When the operation direction is left, i.e., in the case of the left-direction steering correction signal (LEFT), the process progresses to step S09, the switch operation determining unit 290A sets a negative sign −, and outputs the set sign to the output waveform computing unit 297A (see FIG. 3). After the steps S08 and S09, the process progresses to step S10.

The output waveform computing unit 297A multiplies the reference current pulse waveform X0 input from the reference waveform setting unit 291A in the step S05 by the sign corresponding to the operation direction and the gain K input from the gain setting unit 292A in the step S06 to generate the current waveform of the additional current value I_{Ad}, and outputs the generated current waveform to the additional current-output control unit 298 in the step S10 (GENERATE CURRENT WAVEFORM OF ADDITIONAL CURRENT VALUE I_{Ad}). When 0 (zero) signal is input into the output waveform computing unit 297A from the reference waveform setting unit 291A, the output waveform computing unit 297A multiplies 0 by the sign corresponding to the operation direction and the gain K input from the gain setting unit 292A, and outputs 0 (zero) signal to the additional current-output control unit 298 (see FIG. 3).

The additional current-output control unit 298 temporally holds the current waveform of the additional current value I_{Ad} generated in the step S10, and outputs the additional current value I_{Ad} to the adder 252 (see FIG. 3) for each time step in accordance with the current waveform of the additional current value I_{Ad} in step S11. After the step S11, the process progresses to step S12 in FIG. 12 through a node (A).

The adder 252 adds the q-axis target current value I_{TG1} with the additional current value I_{Ad} to generate the q-axis target current value Iq*, and outputs the generated current value to the subtractor 253 (see FIG. 3) in the step S12. Thereafter, like the control unit of a normal electric power steering device 100, the motor 11 (see FIG. 3) is driven under a feedback control of a q-axis actual current value Iq and a d-axis actual current value Id.

After the additional current-output control unit 298 outputs the additional current value I_{Ad} for each time step in accordance with the current waveform of the additional current value I_{Ad}, 0 (zero) signal is output to the adder 252. Moreover, when the output waveform computing unit 297A inputs 0 (zero) signal to the additional current-output control unit 298, 0 (zero) signal is output to the adder 252.

That is, the adder 252 realizes the turning-angle target change level for rotating the motor 11 by the predetermined amount in response to the right-direction or left-direction steering correction signal in accordance with the operation to the operation switch 2aL or 2aR.

The switch operation determining unit 290A checks in step S13 whether or not the timer t having started in the step S04 reaches the threshold time tₜₕ input from the output waveform monitoring unit 299. When the timer t reaches the threshold time tₜₕ (step S13: YES), the process progresses to step S14, the flag is set to be IFLAG=0, and the process progresses to step S16. When the timer t does not reach the threshold time tₜₕ (step S13: NO), the process progresses to step S15, the flag is set to be IFLAG=1, and the process progresses to step S16.

The switch operation determining unit 290A checks in the step S16 whether or not the right-direction or left-direction steering correction signal is received from at least either one of the operation switches 2aL and 2aR (OPERATION SWITCH FROM OFF TO ON?). When the right-direction or left-direction steering correction signal is received (step S16: YES), the process progresses to step S17, and when no such signal is received (step S16: NO), the process progresses to step S20.

It is checked in the step S17 whether or not IFLAG=0. When IFLAG=0 (step S17: YES), the process progresses to step S18. When IFALG≠0 (step S17: NO), the process returns to the step S11 in FIG. 11 through a node (C). That is, the switch operation determining unit 290A does not receive (ignores) the right-direction or left-direction steering correction signal received from either one of the operation switches 2aL and 2aR in the step S16.

The switch operation determining unit 290A resets the timer t in the step S18, and also resets to be 0 (zero) in step S19 the output of the additional current value I_{Ad} currently output by the additional current-output control unit 298. Next, the additional current-output control unit 298 clears the current waveform of the additional current value I_{Ad} temporally held in the step S11. Thereafter, the process returns to the step S03 in FIG. 11 through a node (B).

Hence, the additional current-output control unit 298 forcibly causes the output of the additional current value I_{Ad} to be 0 (zero) and terminates the output of the additional current value without outputting the falling part of the current waveform of the additional current value I_{Ad} currently output to the adder 252 until its end. However, since the time has elapsed over the threshold time tₜₕ, the absolute value of the additional current value I_{Ad} has decreased to equal to or lower than the wave height (H0×K)/e, and the strangeness of the motion of the steering wheel 2 is little, the next steering correction operation to the former steering correction operation can be received from the operation switches 2aL and 2aR, and thus it becomes possible to rapidly respond to the operation desired by the driver.

When the determination result in the step S16 is No and the process progresses to the step S20, the switch operation determining unit 290A checks whether or not the timer t reaches t4 (see FIG. 5A). When the timer t reaches t4 (step S20: YES), the process progresses to step S21, the timer t is reset, the successive current waveform generation of the additional current value I_{Ad} and the output control based on the right-direction or left-direction steering correction signal are terminated, and the process returns to the step S01.

When the timer t does not reach t4 in the step S20 (step S20: NO), the process returns to the step S11 in FIG. 11 through the node (C).

According to this embodiment, through an ON operation to either one of the operation switches 2aL and 2aR of the steering wheel 2 (see FIG. 1), regardless of the time length of the ON state of such a switch, a predetermined steering correction operation in accordance with the vehicle speed VS can be performed independently from the turning operation (steering input) to the steering wheel 2. In the case of the direct steering correction operation to the steering wheel 2, a steering effort of substantially 1 Nm is necessary, but such a steering effort is replaced by the operation to the operation switches 2aL and 2aR, thereby reducing the load to the driver while turning the steering wheel 2.

The retain time of the ON states of the operation switches 2aL and 2aR is affected by the reflexes of the driver, the time sense thereof, and steering counterforce originating from the steering angle θ_{H} of the steering wheel 2, etc. Moreover, since the operation switches 2aL and 2aR are slide type, the retain time of the ON states of the operation switches 2aL and 2aR may have a change to be long or short due to a kick-back from the road surface during the operation of the operation switches 2aL and 2aR.

Hence, if the correction level of the steering is set in accordance with the retain time of the ON states of the operation switches 2aL and 2aR, it does not become the steering correction operation expected by the driver in some cases, and the driver feels strangeness, or a steering correction operation in the opposite direction may become necessary. Accordingly, when the predetermined steering correction operation is performed upon detection of the ON state at one time like this embodiment, the driver can use the operation switches 2aL and 2aR with ease.

Moreover, since the effective range Rθ_{H} of the steering angle θ_{H} that accepts the operation to the operation switches 2aL and 2aR is set to, for example, −30 degrees≦θ_{H}≦+30 degrees, if the driver falsely operates the operation switches 2aL and 2aR because of some reason at the steering angle θ_{H} that makes the slide operation of the operation switches 2aL and 2aR difficult, no steering correction signal is received in the step S03 of the flowchart of FIG. 11, which does not give strangeness to the driver due to the false operation.

Furthermore, when the current waveform of the additional current value I_{Ad} based on a steering correction signal is generated and the additional current value I_{Ad} based on the current waveform thereof is being output at a time step, the next steering correction signal is not received until the timer t reaches or exceeds the threshold time tₜₕ. Accordingly, it becomes possible to avoid a steering correction operation unexpected by the driver.

Such an event occurs when, for example, a disturbance such as turning the steering wheel 2 further to the left while a steering correction operation to the left direction is given to the operation switches 2aL and 2aR occurs, and the operation switches 2aL and 2aR generate a steering correction signal to the right direction.

### First Modified Example of First Embodiment

According to the first embodiment, as shown in FIGS. 5A and 5B, when the output waveform computing unit 297A generates the current waveform of the additional current value I_{Ad}, the output waveform monitoring unit 299 calculates the threshold time tₜₕ that is a timing at which the output of the output current of the additional current value I_{Ad} is started, reaches the wave height (H0×K)/e, starts falling and such a wave height becomes lower than the value of (H0×K)/e, and the threshold time tₜₕ is input into the switch operation determining unit 290A. However, the present invention is not limited to such a configuration.

The output waveform monitoring unit 299 may monitor in the step S13 in FIG. 12 the additional current value I_{Ad} for each time step and output from the additional current-output control unit 298 indicated by an arrow of a dashed line based on the current waveform of the additional current value I_{Ad} generated by the output waveform computing unit 297A, set IFLAG=0 in the step S14 when the additional current value I_{Ad} becomes lower than the value of the (H0×K)/e (step S13: YES) after the additional current value I_{Ad} exceeds the maximum wave height value (H0×K), and set IFLAG=1 in the step S15 when it does not still become lower than the value of the (H0×K)/e (step S13: NO), and the value of the flag IFLAG may be output to the switch operation determining unit 290A.

### Second Modified Example of First Embodiment

According to the first embodiment, in the steps S03 to S10 in FIG. 11, the explanation was given based on the presumption to the above-explained first method explained in the paragraph “0068” that is a control method of outputting/not outputting the additional current value I_{Ad} on the basis of the combination of the function of the operation switch validity determining unit 295 which determines that the operation to the operation switches 2aL and 2aR is valid, and the function of the switch operation determining unit 290A.

However, the present invention is not limited to such a method, and the second method explained in the paragraphs “0069” and “0070” may be applied. In this case, when the determination result in the step S03 is NO, the operation switch validity determining unit 295 further determines whether or not the steering angle θ_{H} is, for example, within 90 degrees to the right and left. When the steering angle is within 90 degrees to the right and left, in the case of a left steering, a flag signal that invalidates the ON signal from the operation switch 2aL and in the case of a right steering, a flag signal that invalidates the ON signal from the operation switch 2aR is input by the operation switch validity determining unit 295 into the switch operation determining unit 290A, and the process progresses to the step S04.

When, for example, the steering angle θ_{H} exceeds 90 degrees to the right and left, the process is returned to the step S02.

Furthermore, the step S07 in FIG. 11 is read as “the switch operation determining unit 290A checks whether or not receiving the flag signal that invalidates the ON signal to either one of the operation switches 2aL and 2aR from the operation switch validity determining unit 295, invalidates the ON signal from the operation switch 2aL or 2aR subjected to such a flag signal, and determines whether the operation direction indicated by the operated operation switch 2aL or 2aR with respect to the ON signal not invalidated is right or left”. When the operation direction is right, i.e., in the case of the right-direction steering correction signal (RIGHT), the process progresses to the step S08, the switch operation determining unit 290A sets a positive sign +, and outputs the set sign to the output waveform computing unit 297A. When the operation direction is left, i.e., in the case of the left-direction steering correction signal (LEFT), the process progresses to the step S09, the switch operation determining unit 290A sets a negative sign −, and outputs the set sign to the output waveform computing unit 297A (see FIG. 3).

Accordingly, when the steering angle θ_{H} is out of the predetermined range Rθ_{H} and the steering angle θ_{H} is within a range of, for example, −90 degrees≦θ_{H}≦+90 degrees to the right and left, the additional current value I_{Ad} can be output with respect to the operation switch 2aL or 2aR at a side intuitively matching the slide direction of the operation switch 2aL or 2aR with the direction of the steering correction. Hence, the steering correction operation in the direction intended by the driver can be surely performed through the operation switch 2aL or 2aR within a wide range of the steering angle θ_{H}.

### Second Embodiment

Next, with reference to FIGS. 13 to 19, and FIG. 1 as needed, an explanation will be given of an electric power steering device 100 according to a second embodiment of the present invention.

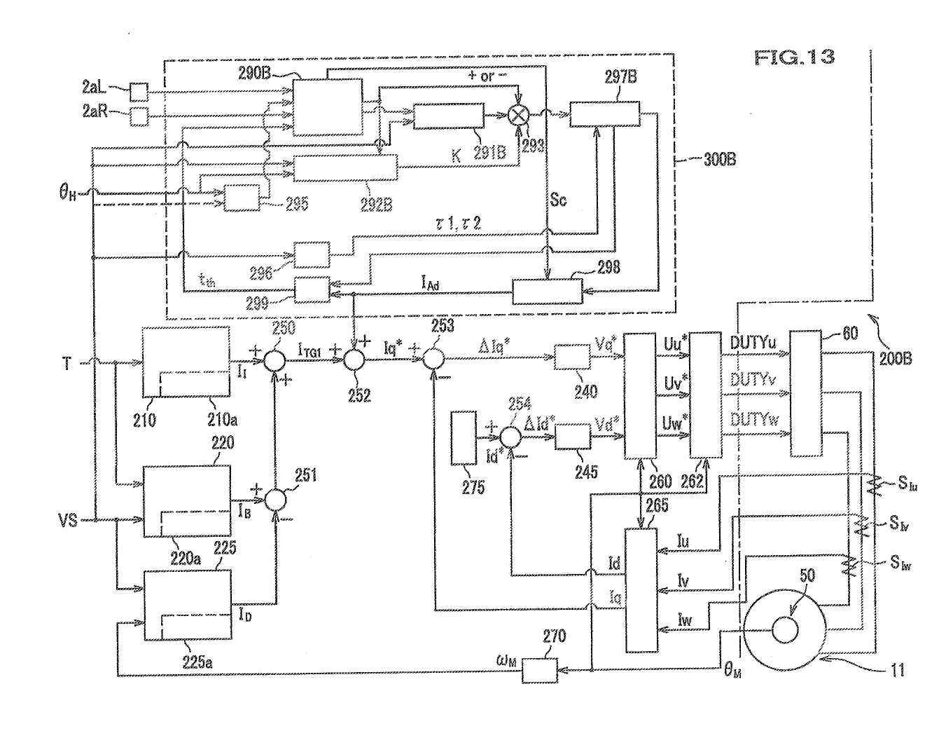

FIG. 13 is a functional block configuration diagram of a control device according to the second embodiment.

The difference of a control device 200B of the second embodiment from the control device 200A of the first embodiment is that the additional current computing unit 300A is replaced with an additional current computing unit (additional current computing unit) 300B. The same structural element as that of the first embodiment will be denoted by the same reference numeral, and the duplicated explanation thereof will be omitted.

<<Additional Current Computing Unit 300B and Adder 252>>

As shown in FIG. 13, the additional current computing unit 300B includes a switch operation determining unit 290B, a reference waveform setting unit 291B, a gain setting unit (a steering condition detecting unit) 292B, a multiplier 293, the operation switch validity determining unit 295, a time constant setting unit 296, an output waveform computing unit 297B, the additional current-output control unit 298, and the output waveform monitoring unit 299. The additional current value I_{Ad} output by the additional current-output control unit 298 is input into the adder 252. Next, the adder 252 adds the q-axis target current value I_{TG1} output by the adder 250 and the additional current value I_{Ad}, and the q-axis target current value Iq* is output to the subtractor 253.

The configuration and the function of the additional current computing unit 300B will be explained below in more detail.

The control process by the additional current computing unit 300B is executed by the CPU thereof at a certain process cycle, e.g., the cycle of 10 msec like the above-explained base signal computing unit 220, inertia compensation signal computing unit 210, damper correction signal computing unit 225, q-axis PI control unit 240, d-axis PI control unit 245, two-axis three-phase converter unit 260, PWM converter unit 260, three-phase two-axis converter unit 265, and exciting current generating unit 275, etc.

<Switch Operation Determining Unit 290B>

Input into the switch operation determining unit 290B are the switch signals from the operation switches 2aL and 2aR, and a signal of the determination result by the operation switch validity determining unit 295. When the signal of the determination result from the operation switch validity determining unit 295 indicates the validity, if the right-direction or left-direction steering correction signal from the operation switch 2aL or 2aR is input, the switch operation determining unit 290B inputs the reference waveform output signal to the reference waveform setting unit 291B, inputs the positive (+) signal to the multiplier 293 and the gain setting unit 292B with respect to the right-direction steering correction signal, and inputs the negative (−) signal thereto with respect to the left-direction steering correction signal.

Moreover, the switch operation determining unit 290B receives the input of a predetermined threshold time tₜₕ to be discussed later from the output waveform monitoring unit 299, and when a timer t reaches the predetermined threshold time tₜₕ after the output of the current waveform of the additional current value I_{Ad} is started from the timer t=0 to be discussed later, receives the input of the new switch signals from the OFF state to the ON state of the operation switches 2aL and 2aR. Next, after the predetermined threshold time tₜₕ, if the additional current-output control unit 298 is still outputting the additional current value I_{Ad}, when the input of the new switch signals from the operation switches 2aL and 2aR are received, the switch operation determining unit 290B outputs a control signal Sc to the additional current-output control unit 298 to once terminate the former output of the additional current value I_{Ad}, to set the additional current value I_{Ad} to be 0 (zero).

<Reference Waveform Setting Unit 291B>

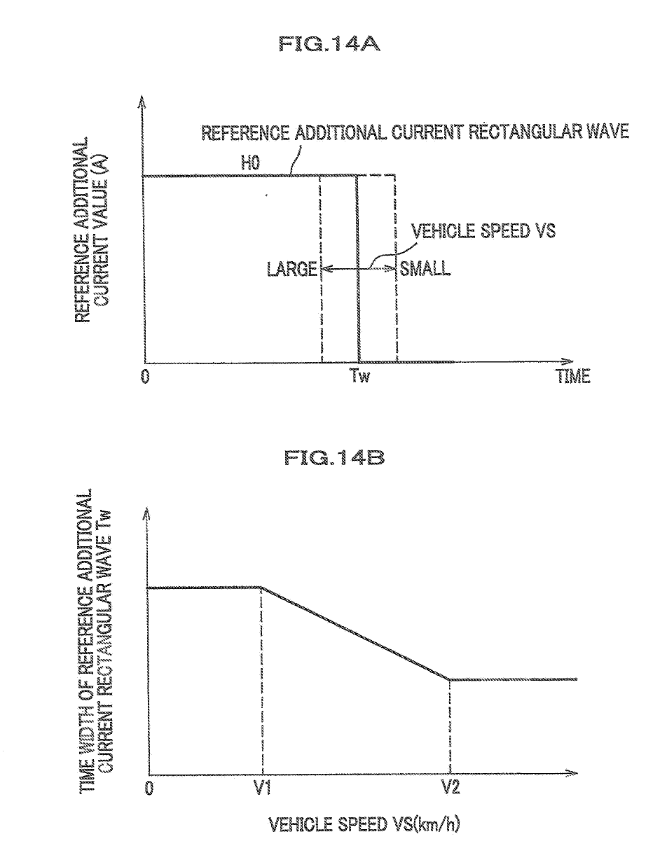

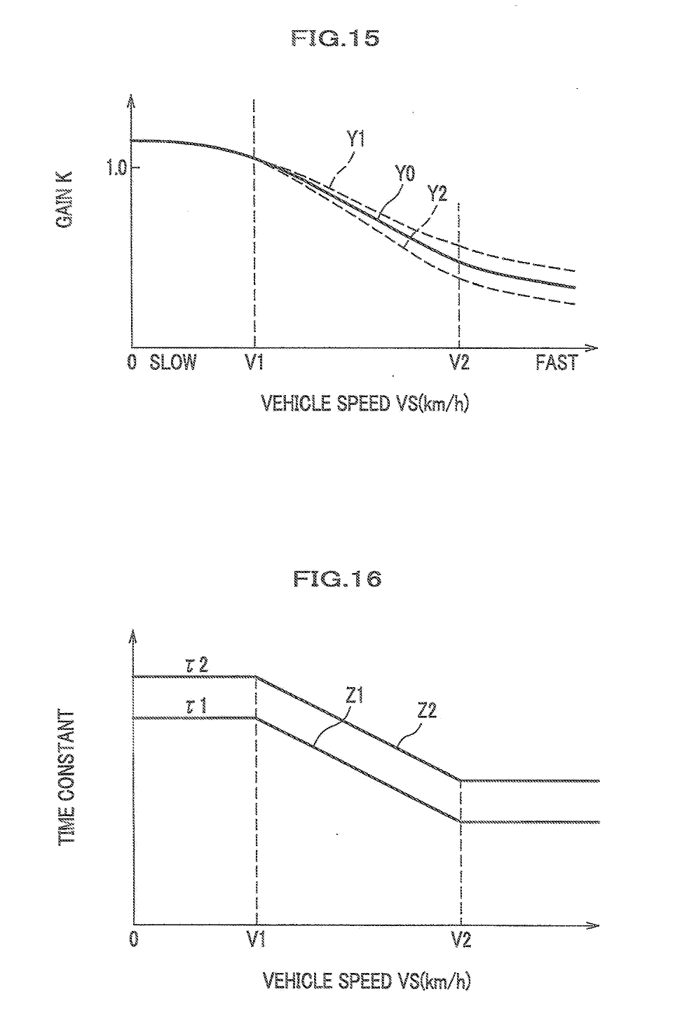

Next, an explanation will be given of the reference waveform setting unit 291B with reference to FIGS. 14A and 14B. FIGS. 14A and 14B are explanatory diagrams for generation of the additional current value waveform by the additional current computing unit shown in FIG. 13, FIG. 14A is an explanatory diagram for setting of the time width of a reference additional current rectangular wave in accordance with the vehicle speed VS, and FIG. 14B is an explanatory diagram for a change in the time width of the reference additional current rectangular wave in accordance with the vehicle speed VS.

When the reference waveform output signal is input from the switch operation determining unit 290B, the reference waveform setting unit 291B sets, as shown in FIG. 14B, a time width Tw (conducting time) of the current waveform of the reference additional current value in accordance with the vehicle speed VS, and generates the current waveform of the reference additional current value as a rectangular pulse waveform as shown in FIG. 14A. The current waveform of the reference additional current value with the rectangular pulse waveform is also referred to as a “reference additional current rectangular wave”. Pieces of data on a wave height H0 of the reference additional current rectangular wave and the time width Tw in accordance with the vehicle speed VS are set in advance through a test, are stored in the ROM in advance, and read and used.

The reference additional current rectangular wave generated by the reference waveform setting unit 291B is input into the multiplier 293.

The time width Tw of the reference additional current rectangular wave is, as shown in FIG. 14B, a constant value when the vehicle speed VS is V1, e.g., equal to or slower than substantially 40 km/h, for example, linearly decreases as the vehicle speed VS increases toward V2, and is fixed to a predetermined constant saturated value when the vehicle speed VS is V2, e.g., equal to or faster than substantially 100 km/h.

<Gain Setting Unit 292B>

Next, with reference to FIG. 15, an explanation will be given of the gain setting unit 292B. FIG. 15 is an explanatory diagram for a gain setting the wave height of the additional current value waveform in accordance with the vehicle speed VS by the gain setting unit shown in FIG. 13.

The gain setting unit 292B refers to the gain characteristic data shown in FIG. 15 and stored in the ROM in advance, obtains the value of the gain K in accordance with the vehicle speed VS, and inputs the obtained value in the multiplier 293.

The gain characteristic data has, as shown in FIG. 15, a reference gain curve Y0 indicated by a reference numeral Y0, an increased-steering correction gain curve Y1 indicated by a reference numeral Y1, and a steering returning correction gain curve Y2 indicated by a reference numeral Y2. The reference gain curve Y0, the increased-steering correction gain curve Y1 and the steering returning correction gain curve Y2 have characteristics such that a value of the gain K is equal to or greater than 1.0 when the vehicle speed VS is slow, but the decrease level of the gain K gradually becomes sharp as the vehicle speed VS increases and the value of the gain K decreases linearly, and the value of the gain K is substantially saturated at a predetermined vehicle speed VS or faster.

The increased-steering correction gain curve Y1 gradually becomes apart upwardly from the reference gain curve Y0 when the vehicle speed VS exceeds the above-explained value V1, the difference between the gain K of the reference gain curve Y0 and the gain K of the increased-steering correction gain curve Y1 increases, and becomes a constant difference at the vehicle speed VS that is equal to or greater than the above-explained value V2.

On the other hand, the steering returning correction gain curve Y2 gradually becomes apart downwardly from the reference gain curve Y0 when the vehicle speed VS exceeds the above-explained value V1, the difference between the gain K of the reference gain curve Y0 and the gain K of the steering returning correction gain curve Y2 increases, and becomes a constant difference at the vehicle speed VS that is equal to or greater than the above-explained value V2.

Next, the gain setting unit 292B inputs the gain K in accordance with the vehicle speed VS and set using the reference gain curve Y0 into the multiplier 293 within a range of a third threshold of the predetermined steering angle θ_{H} to the right and left from the neutral position of the steering angle θ_{H} set in accordance with the vehicle speed VS. The range within the third threshold of the predetermined steering angle θ_{H} to the right and left from the neutral position of the steering angle θ_{H} set in accordance with the vehicle speed VS is a narrower range than the predetermined range Rθ_{H} set around the neutral position of the steering angle θ_{H}.

Within the range to the right and left out of the third threshold of the predetermined steering angle θ_{H} to the right and left from the neutral position of the steering angle θ_{H} set in accordance with the vehicle speed VS, it is determined whether or not the sign of the steering angle θ_{H} is consistent with the sign indicating the direction of the steering correction operation input from the switch operation determining unit 290B, and the increased-steering correction gain curve Y1 or the steering returning correction gain curve Y2 is separately used depending on the determination result.

That is, within the range to the right and left out of the third threshold of the predetermined steering angle θ_{H} to the right and left from the neutral position of the steering angle θ_{H} set in accordance with the vehicle speed VS, when the sign of the steering angle θ_{H} is consistent with the sign indicating the direction of the steering correction operation input from the switch operation determining unit 290B, it means an increased-steering correction operation, and when the sign is different, it means a steering returning correction operation.

When it is determined as the increased-steering correction operation, the gain K in accordance with the vehicle speed VS and set using the increased-steering correction gain curve Y1 is input into the multiplier 293.

When it is determined as the steering returning correction operation, the gain K in accordance with the vehicle speed VS and set using the steering returning correction gain curve Y2 is input into the multiplier 293.

The third threshold of the predetermined steering angle θ_{H} to the right and left from the neutral position is set to be wide to the right and left around the neutral position when the vehicle speed VS is slow, and to become narrower as the vehicle speed VS becomes faster.

The reason why the reference gain curve Y0, the increased-steering correction gain curve Y1, and the steering returning correction gain curve Y2 are separately used is that a self-aligning torque changes in accordance with the vehicle speed VS, and when the steering correction operation is performed using the operation switches 2aL and 2aR with the steering angle θ_{H} exceeding the third threshold of the predetermined steering angle θ_{H} to the right and left from the neutral position, there is a difference in the steering assist force to be output by the motor 11 between the increased steering side and the return steering side even if it is attempted to obtain the same target change level of the turning angle δ. Accordingly, such a difference is corrected to stably obtain the target change level of the turning angle δ.

The gain characteristic data is set in advance depending on the setting of the turning-angle target change level for turning the front wheels 10F, 10F (see FIG. 1) in consideration of a combination of the current-output characteristic of the motor 11 used for the electric power steering device 100, the turning load in accordance with the vehicle speed VS at the time of the turning of the vehicle, and the time width Tw of the reference additional current rectangular wave of the reference waveform setting unit 291B with respect to the current waveform of an additional current value I_{Ad} in accordance with the vehicle speed VS.

First, the turning-angle target change level by the current waveform of an additional current value I_{Ad} is set to be large when the vehicle speed VS is slow and to be small when the vehicle speed VS is fast. For example, the turning-angle target change level is set to be 0.5 degrees at the vehicle speed equal to or faster than substantially 100 km/h, be 3 degrees at the vehicle speed equal to or slower than substantially 40 km/h, and become linearly interpolated turning-angle target change level between 40 to 100 km/h. In addition, the time width Tw of the reference additional current rectangular wave shown in FIGS. 14A and 14B and the gain characteristic data shown in FIG. 15 are set in consideration of the current-output characteristic of the motor 11, and the turning load of the front wheels 10F, 10F against the road surface through a test using an actual vehicle or a simulation so as to obtain the above-explained turning-angle target change level.

<Multiplier 293>

The multiplier 293 multiplies the reference additional current rectangular wave input from the reference waveform setting unit 291B by the gain K input from the gain setting unit 292B, and inputs a rectangular additional current value waveform to the output waveform computing unit 297B.

<Time Constant Setting Unit 296>

Next, with reference to FIG. 16, the time constant setting unit 296 will be explained. FIG. 16 is an explanatory diagram for a setting of a rising time constant τ1 and a falling time constant τ2 in accordance with the vehicle speed VS used for performing a temporal delay process on the rectangular pulse waveform that is the current waveform of the reference additional current value by an output waveform reshaping unit shown in FIG. 13.

The time constant setting unit 296 sets the predetermined time constants τ1 and τ2 for causing the output waveform computing unit 297B to reshape (temporally delay) the rising and falling of the rectangular additional current value waveform input into the output waveform computing unit 297B from the multiplier 293 to the current waveform of the additional current value I_{Ad} having a gentle rising and falling. The characteristic data of the time constants τ1 and τ2 in accordance with the value of the vehicle speed VS is stored in the ROM in advance as a map.

The time constant τ1 is for a temporally delay process for rising, and the time constant τ2 is for a temporally delay process for falling. In the following explanation, the time constant τ1 is referred to as a “rising time constant τ1”, and the time constant τ2 is referred to as a “falling time constant τ2”.

As shown in FIG. 16, the time constant τ2 has a value set to be larger than the value of the time constant τ1 but in accordance with the vehicle speed VS, is a predetermined constant value when the vehicle speed VS is V1, e.g., equal to or slower than substantially 40 km/h, decreases at the same decrease ratio as the vehicle speed VS increases when the vehicle speed VS exceeds V1 and is less than V2, e.g., slower than substantially 100 km/h, and becomes a predetermined constant value when the vehicle speed VS is equal to or faster than V2.

The reason why the values of the time constants τ1 and τ2 are changed in accordance with the vehicle speed VS is that the faster the vehicle speed VS is, the quicker the responsiveness is required which is the responsiveness of the steering correction operation through the operation to the operation switches 2aL and 2aR. It is clear from the time width of the transition of the steering correction operation of the steering effort as time advances shown in FIGS. 9B and 10B that a quick responsiveness for the steering correction operation is necessary at a faster vehicle speed.

<Output Waveform Computing Unit 297B>

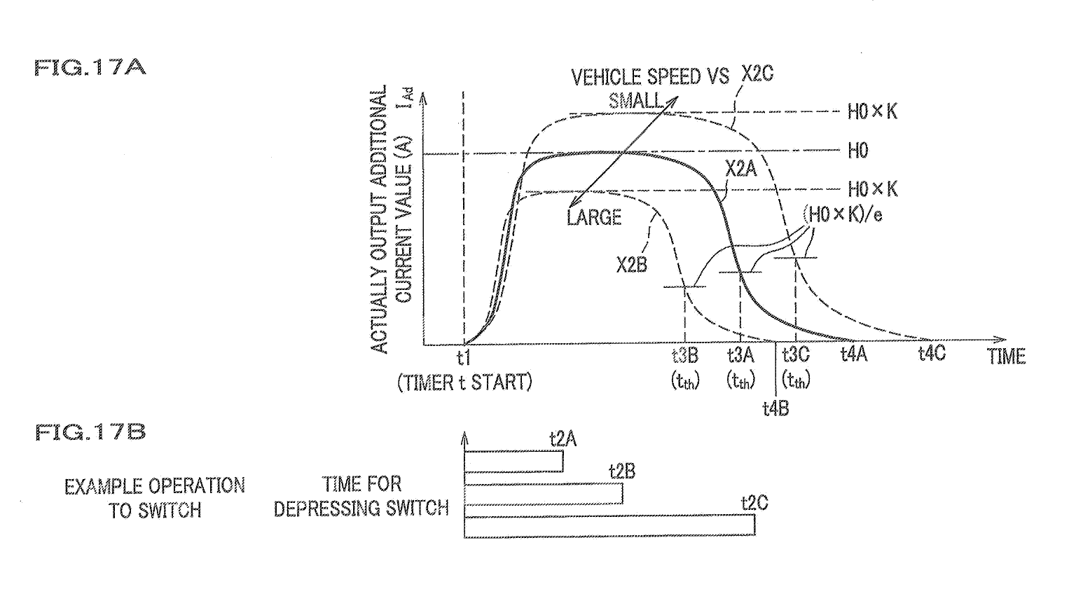

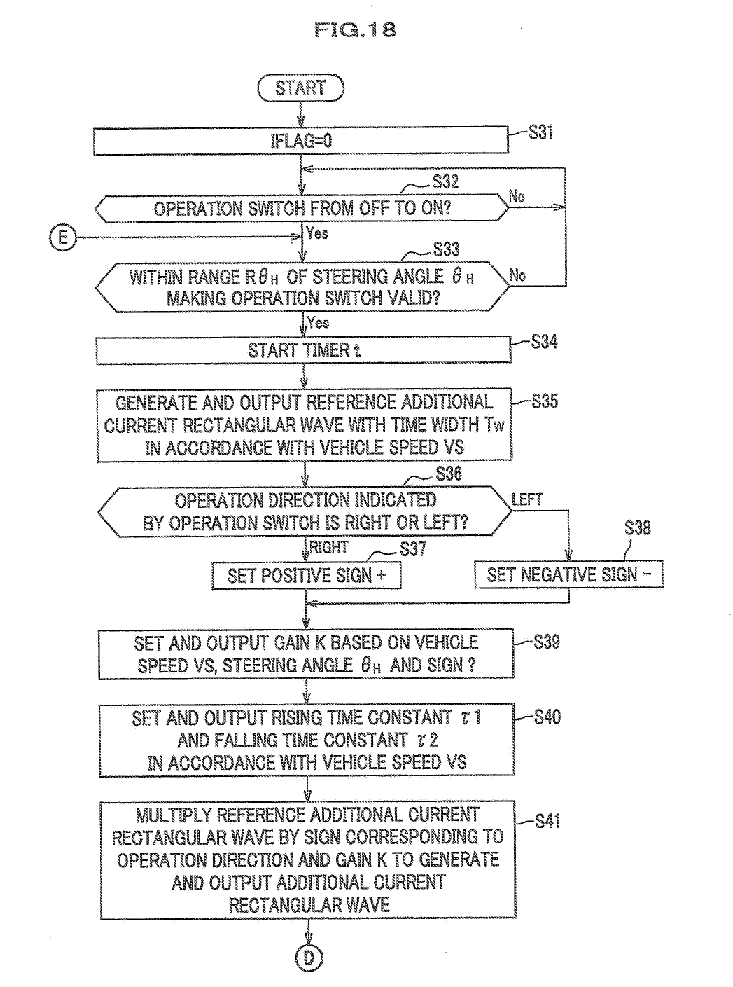

Next, with reference to FIGS. 17A and 17B, the output waveform computing unit 297B will be explained. FIGS. 17A and 17B are explanatory diagrams for an additional current value waveform by the additional current computing unit 300B in FIG. 13. FIG. 17A is an explanatory diagram for the transition of the output additional current value as time advances, and FIG. 17B is an explanatory diagram that the time length of the ON state of the operation switch provided at the steering wheel does not affect the output additional current value waveform.

Upon inputting of the rectangular additional current value waveform from the multiplier 293, the output waveform computing unit 297B generates the current waveform of the additional current value I_{Ad} having undergone reshaping processes for temporally delaying rising and falling using the time constant τ1 for the temporal delay process for rising and the time constant τ2 for the temporal delay process for falling both input from the time constant setting unit 296, and inputs the generated current waveform in the additional current-output control unit 298.

As shown in FIG. 17A, since the time width Tw (see FIGS. 14A and 14B) of the current waveform of the additional current value I_{Ad} and the value of the gain K (see FIG. 15) change in accordance with the value of the vehicle speed VS, the smaller the value of the vehicle speed VS is, the larger the time width Tw of the current waveform becomes and the larger the value of the gain K becomes, so that a current waveform of the additional current value I_{Ad} indicated by a reference numeral X2C is obtained. Moreover, the larger the value of the vehicle speed VS is, the smaller the time width Tw of the current waveform of the additional current value I_{Ad} and the value of the gain K become, so that current waveforms of the additional current value I_{Ad} indicated by reference numerals X2A and X2B are obtained.

The current waveform of the additional current value I_{Ad} indicated by the reference numeral X2A is obtained when the gain K=1.0, the current waveform of the additional current value I_{Ad} indicated by the reference numeral X2B is obtained when the gain K<1.0, and the current waveform of the additional current value I_{Ad} indicated by the reference numeral X2C is obtained when the gain D>1.0.

The reason why the current waveform of the additional current value I_{Ad} is, as shown in FIG. 17A, not a rectangular wave but rises and falls gently is the same as that of the first embodiment.

When the current waveform of the additional current value I_{Ad} has the time width and the wave height changed in accordance with the value of the vehicle speed VS, it becomes easy to realize the above-explained turning-angle target change level more flexibly.

In FIG. 17A, a time t1 indicates a timing at which the driver operates either one of the operation switches 2aL and 2aR and such an operation switch becomes an ON state, and times t4A, t4B, and t4C indicate timings at which the current waveform of the additional current value I_{Ad} that starts rising at the time t1 falls to 0 (zero).

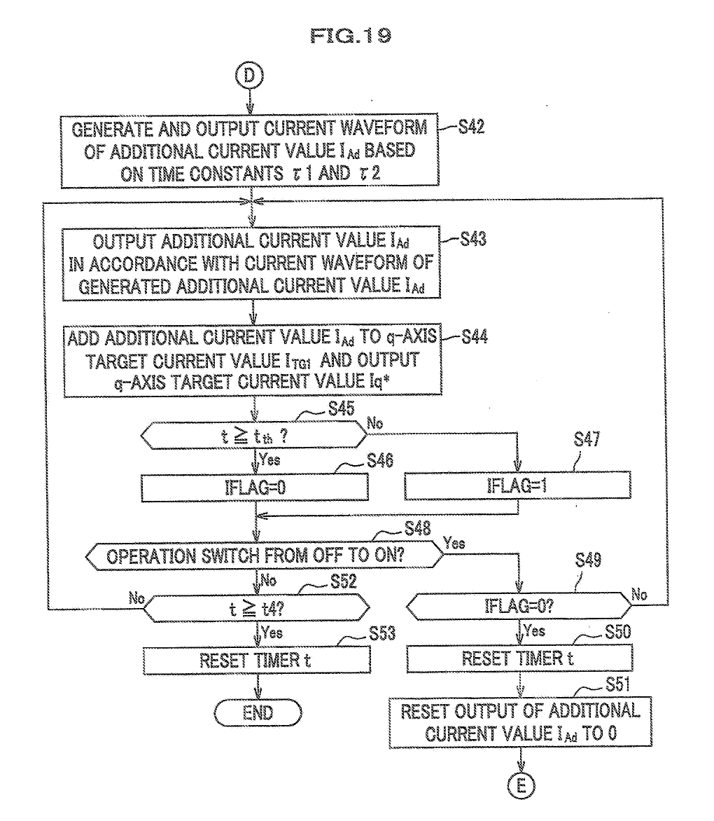

The time t1 corresponds to a timing of starting the timer t in step S34 to be discussed later in the flowchart of FIG. 18. A time t3 (in FIG. 17A, indicated as times t3A, t3B, and t3C) to be discussed later corresponds to a threshold time tₜₕ in step S45 in the flowchart of FIG. 19.

The current waveform of the additional current value I_{Ad} in accordance with the value of the vehicle speed VS is obtained by multiplying the reference additional current rectangular wave shown in FIG. 14A by a positive/negative (±) sign and the gain K, and performing a reshaping process of a temporal delay on the multiplication result using the time constant τ1 for the temporal delay process for rising and the time constant τ2 for the temporal delay process for falling, and is the current waveform of the additional current value I_{Ad} of the predetermined time length within the range between the times t1 to t4 (in FIG. 17A, indicated as times t4A, t4B, and t4C). The time t3 indicated in FIG. 17A (in FIG. 17A, indicated as times t3A, t3B, and t3C) is a time when the current waveform of the actually output additional current value I_{Ad} becomes the value of, for example, (H0×K)/e, and the time t3 (tₜₕ) is not a constant value in this embodiment.

H0 indicates the wave height of the reference additional current rectangular wave, and e is a bottom value of a natural logarithm.

Lateral bars indicated in FIG. 17B corresponding to the time axis in FIG. 17A are to explain that when the ON states of the operation switches 2aL and 2aR start from the time t1 but the end time of the ON state differs like t2A, t2B and t2C, the switch operation determining unit 290B generates only the current waveform of an additional current value I_{Ad} between the times t1 to t4 (in FIG. 17A, indicated as times t4A, t4B, and t4C).

<Additional Current-Output Control Unit 298>

Upon inputting of the current waveform of the additional current value I_{Ad} from the output waveform computing unit 297B, the additional current-output control unit 298 temporally holds current waveform data, and outputs the additional current value I_{Ad} in accordance with the current waveform at a constant cycle in a time-series manner, i.e., at a time step, e.g., a cycle of 10 msec to the adder 252.

When the control signal Sc is input from the switch operation determining unit 290B, the additional current-output control unit 298 causes the currently output additional current value I_{Ad} to be 0 (zero) to terminate the output, and clears the current waveform data temporally held.

<Output Waveform Monitoring Unit 299>

The output waveform monitoring unit 299 calculates, when the output waveform computing unit 297B generates the current waveform of the additional current value I_{Ad} as shown in FIG. 17A, the threshold time tₜₕ that is a timing at which the current waveform starts falling after the output of the output current of the additional current value I_{Ad} is started and reaches the wave height (H0×K) and the wave height becomes lower than the value of (H0×K)/e, and inputs the calculated threshold time tₜₕ into the switch operation determining unit 290B. According to this embodiment, as explained above, the threshold time tₜₕ is not a fixed value.

The setting of the threshold time tₜₕ is made based on a standpoint that the output of the current waveform of the additional current value I_{Ad} becomes a falling state and can be deemed as being attenuated to the wave height where a predetermined steering correction operation substantially completes, and a standpoint that even if the additional current value I_{Ad} currently output is set to be 0 (zero) to terminate the output, the driver does not feel large strangeness, and is not limited to the timing of becoming lower than the value of (H0×K)/e.

<Generation and Output Control of Additional Current by Additional Current Computing Unit 300B>

Next, with reference to FIGS. 18 and 19 and FIG. 13 as needed, an explanation will be given of the output control of the additional current value I_{Ad} by the additional current computing unit 300B. FIGS. 18 and 19 are flowcharts showing a flow of generation and output control of the additional current value waveform by the additional current computing unit shown in FIG. 13.

Steps S31, S32, S33, S34, S36, S37, S38, and S43 to S53 in the flowcharts of FIGS. 18 and 19 of this embodiment correspond to the steps S01, S02, S03, S04, S07, S08, S09, and S11 to S21 in the flowcharts of FIGS. 11 and 12 of the first embodiment, and the switch operation determining unit 290A is read as the switch operation determining unit 290B.

First, the switch operation determining unit 290B (see FIG. 13) resets the flag to be IFLAG=0 in step S31.

The switch operation determining unit 290B checks in step S32 whether or not the right-direction or left-direction steering correction signal is received from at least either one of the operation switches 2aL and 2aR (OPERATION SWITCH FROM OFF TO ON?). When the right-direction or left-direction steering correction signal is received (step S32: YES), the process progresses to step S33, and when no such a signal is received (step S32: NO), the process returns to the step S32.

The switch operation determining unit 290B checks in the step S33 whether or not the steering angle θ_{H} is within the range Rθ_{H} that makes the operation of either one of the operation switches 2aL and 2aR valid. More specifically, the switch operation determining unit 290B determines whether or not receiving the signal indicating that the current steering angle θ_{H} is within the effective range Rθ_{H} where the operation to either one of the operation switches 2aL and 2aR is valid from the operation switch validity determining unit 295 (see FIG. 13). When the steering angle θ_{H} is within the range Rθ_{H} that makes the operation to either one of the operation switches 2aL and 2aR valid (step S33: YES), the process progresses to step S34, and when such a steering angle is out of such a range (step S33: NO), the process returns to the step S32.

The switch operation determining unit 290B starts the timer t and inputs the reference waveform output signal to the reference waveform setting unit 291B in the step S34. The reference waveform setting unit 291B (see FIG. 13) generates the reference additional current rectangular wave (see FIG. 14A) with the time width Tw in accordance with the vehicle speed VS upon reception of the reference waveform output signal from the switch operation determining unit 290B, and outputs the generated reference additional current rectangular wave into the multiplier 293 (see FIG. 13) in step S35. When receiving no reference waveform output signal from the switch operation determining unit 290B, the reference waveform setting unit 291B outputs 0 (zero) signal to the multiplier 293.

The switch operation determining unit 290B determines in step S36 whether the operation direction indicated by the operated operation switch 2aL or 2aR is right or left. When the operation direction is right, i.e., in the case of the right-direction steering correction signal (RIGHT), the process progresses to step S37, and the switch operation determining unit 290B sets a positive sign + and outputs the set sign to the multiplier 293. When the operation direction is left, i.e., in the case of the left-direction steering correction signal (LEFT), the process progresses to step S38, and the switch operation determining unit 290B sets a negative sign − and outputs the set sign to the multiplier 293. After the step S37 or S38, the process progresses to step S39.

The gain setting unit 292B (see FIG. 13) refers to the gain characteristic data shown in FIG. 15 based on the vehicle speed VS, the steering angle θ_{H} and the sign ± set in the step S37 or S38, sets the gain K in accordance with the vehicle speed VS, and outputs the set gain to the multiplier 293 in the step S39.

The time constant setting unit 296 (see FIG. 13) sets the rising time constant τ1 and the falling time constant τ2 shown in FIG. 16 in accordance with the vehicle speed VS, and outputs the set time constants to the output waveform computing unit 297B in step S40.

The multiplier 293 multiplies the reference additional current rectangular wave input from the reference waveform setting unit 291B in the step S35 by the sign corresponding to the operation direction, and the gain K input from the gain setting unit 292B in the step S39, and outputs the multiplication result to the output waveform computing unit 297B in step S41. Thereafter, the process progresses to step S42 in FIG. 19 through a node (D).

When 0 (zero) signal is input from the reference waveform setting unit 291B, the multiplier 293 multiplies 0 by the sign corresponding to the operation direction and the gain K input from the gain setting unit 292B, and outputs 0 (zero) signal to the output waveform computing unit 297B (see FIG. 13).

The output waveform computing unit 297B generates the current waveform of the additional current value I_{Ad} by reshaping the reference additional current rectangular wave multiplied by the sign corresponding to the operation direction and the gain K in the step S41 through the temporal delay process using the rising time constant τ1 and the falling time constant τ2, and outputs the generated current waveform to the additional current-output control unit 298 in step S42 (GENERATE AND OUTPUT CURRENT WAVEFORM OF ADDITIONAL CURRENT VALUE I_{Ad} BY TIME CONSTANTS τ1 AND τ2).

The additional current-output control unit 298 temporally holds the current waveform of the additional current value I_{Ad} generated in the step S43, and outputs the additional current value I_{Ad} to the adder 252 (see FIG. 13) for each time step in accordance with the current waveform of the additional current value I_{Ad}.

The adder 252 adds the q-axis target current value I_{TG1} and the additional current value I_{Ad}, and outputs the q-axis target current value Iq* to the subtractor 253 (see FIG. 13) in step S44. Thereafter, like the control unit of the normal electric power steering device 100, the motor 11 (see FIG. 13) is driven under a feedback control based on the q-axis actual current value Iq and the d-axis actual current value Id.

After outputting the additional current value I_{Ad} for each time step in accordance with the current waveform of the additional current value I_{Ad}, the additional current-output control unit 298 outputs 0 (zero) signal to the adder 252, and when the output waveform computing unit 297B inputs 0 (zero) signal to the additional current-output control unit 298, the additional current-output control unit 298 also outputs 0 (zero) signal to the adder 252.

That is, the adder 252 causes the motor 11 to rotate by a predetermined level in accordance with the right-direction or left-direction steering correction signal based on the operation to the operation switch 2aL or 2aR to realize the turning-angle target change level.

After the step S43, as explained above, the processes are the same as the steps S11 to S21 of the flowchart of FIG. 12 according to the first embodiment, the switch operation determining unit 290A is read as the switch operation determining unit 290B, and the duplicated explanation will be omitted. However, after step S51, the process returns to the step S33 in FIG. 18 through a node (E).

Moreover, according to the second embodiment, through the steps S33 to S43 in FIGS. 18 and 19, the explanation was given based on the first method which is explained in the paragraph “0068” and which is the method for controlling output/non-output of the additional current value I_{Ad} based on the combination of the function of the operation switch validity determining unit 295 which determines that the operation to the operation switch 2aL or 2aR is valid and the function of the switch operation determining unit 290B.

However, the present invention is not limited to this method, and the second method explained in the paragraphs “0069” and “0070” may be applied. In this case, in the step S33, when the determination result is NO, the operation switch validity determining unit 295 further determines whether or not the steering angle θ_{H} is, for example, within 90 degrees to the left or right. When the steering angle is within 90 degrees to the right and left, the operation switch validity determining unit 295 inputs, into the switch operation determining unit 290B, a flag signal that invalidates the ON signal from the operation switch 2aL in the case of the steering operation to the left, or a flag signal that invalidates the ON signal from the operation switch 2aR in the case of the steering operation to the right, and the process progresses to the step S34.

When, for example, the steering angle θ_{H} exceeds 90 degrees to the right and left, the process is returned to the step S32.

Moreover, the step S36 in FIG. 18 is read as “the switch operation determining unit 290B checks whether or not receiving a flag signal that invalidates the ON signal to either one of the operation switches 2aL and 2aR from the operation switch validity determining unit 295, invalidates the ON signal with respect to the operation switch 2aL or 2aR associated with the received flag signal, and determines whether the operation direction of the operation to the operation switch 2aL or 2aR with respect to the ON signal not invalidated is right or left”. When the operation direction is right, i.e., in the case of the right-direction steering correction signal (RIGHT), the process progresses to the step S37, the switch operation determining unit 290B sets a positive sign +, and outputs the set sign to the multiplier 293. When the operation direction is left, i.e., in the case of the left-direction steering correction signal (LEFT), the process progresses to the step S38, and the switch operation determining unit 290B sets a negative sign −, and outputs the set sign to the multiplier 293.

Accordingly, when the steering angle θ_{H} is out of the predetermined range Rθ_{H}, and the steering angle θ_{H} to the right and left is, for example, within a range where −90 degrees≦θ_{H}≦+90 degrees, the additional current value I_{Ad} is output with respect to the operation switch 2aL or 2aR having the slide direction thereof intuitively matching the direction of the steering correction direction. Hence, a steering correction operation in the direction intended by the driver can be surely carried out through the operation switch 2aL or 2aR within a further wide range of the steering angle θ_{H}.

According to this embodiment, in addition to the same advantages as those of the first embodiment, the following advantages can be obtained.

According to this embodiment, the wave height of the current waveform of the additional current value I_{Ad} is changed by the gain K in accordance with the vehicle speed VS like the first embodiment, and the time width Tw of the current waveform of the additional current value I_{Ad} is also changed. Hence, when a large turning-angle target change level is set at a slow vehicle speed, the degree of freedom for setting and generation of the current waveform of the additional current value I_{Ad} increases, making the setting easy.

Moreover, a setting can be easily made which enables a quick steering correction operation through the operation switches 2aL and 2aR at a fast vehicle speed.

Furthermore, as shown in FIG. 15, as the gain characteristic curves, three kinds of the reference gain curve Y0, the increased-steering correction gain curve Y1, and the steering returning correction gain curve Y2 are prepared, the gain K is set based on the reference gain curve Y0 within the range of the third threshold of the predetermined steering angle θ_{H} to the right and left from the neutral position of the steering angle θ_{H} and in accordance with the vehicle speed VS. Within the range out of the third threshold of the steering angle θ_{H}, when the direction of the operation to the operation switch 2aL or 2aR matches the increased-steering correction operation, the increased-steering correction gain curve Y1 is used to set the gain K, and when the direction of the operation to such an operation switch matches the steering returning correction operation, the steering returning correction gain curve Y2 is used to set the gain K. Hence, the predetermined steering correction operation expected by the driver in consideration of the change in the steering effort by the self-alignment of the front wheels 10F, 10F is substantially realized in the increased steering direction and the return direction.

### First Modified Example of Second Embodiment

According to the second embodiment, when the output waveform computing unit 297B generates the current waveform of the additional current value I_{Ad} as shown in FIGS. 17A and 17B, the output waveform monitoring unit 299 calculates the threshold time tₜₕ that is a timing at which the output current of the additional current value I_{Ad} reaches the wave height (H0×K) after being output, starts falling and the wave height thereof becomes lower than the value of (H0×K)/e, and inputs the calculated threshold time tₜₕ into the switch operation determining unit 290B, but the present invention is not limited to this operation.

The output waveform monitoring unit 299 may monitor in the step S45 in FIG. 19 the additional current value I_{Ad} output by the additional current-output control unit 298 for each time step based on the current waveform of the additional current value I_{Ad} generated by the output waveform computing unit 297B as indicated by an arrow of dashed lines in FIG. 13. When the additional current value I_{Ad} becomes lower than the value of (H0×K)/e after exceeding the maximum wave height value (H0×K) (step S45: YES), the flag may be set to be IFLAG=0 in the step S46. When such an additional current value does not still become lower than the value of (H0×K)/e (step S45: NO), the flag may be set to be IFLAG=1 in the step S47, and the value of the flag IFLAG in the step S46 or S47 may be output to the switch operation determining unit 290B.

### Second Modified Example of Second Embodiment

According to the second embodiment, the gain setting unit 292B sets the gain K and outputs the set gain to the multiplier 293. However, the gain setting unit 292B may be omitted, and the reference waveform setting unit 291B may change only the time width Tw of the current waveform of the additional current value I_{Ad} in accordance with the vehicle speed VS to set the turning-angle target change level.

### Third Modified Example of Second Embodiment

Moreover, according to the second embodiment, although the gain setting unit 292B sets the gain K in accordance with the vehicle speed VS, the present invention is not limited to this operation.

The additional current computing unit 300B may be configured to input a signal indicating a lateral acceleration from a lateral acceleration sensor that detects a lateral acceleration (driving condition information) to the gain setting unit 292B. In this case, the gain setting unit 292B sets in advance a second gain K2 in such a manner as to be 1.0 when the absolute value of the lateral acceleration is less than a predetermined threshold, and the larger the absolute value of the lateral acceleration becomes, the more the value of the second gain K2 decreases when the lateral acceleration becomes equal to or larger than the predetermined threshold. The gain setting unit 292B may output a product of the gain K and the gain K2 as a corrected gain K to the multiplier 293.

According to such a configuration, when the vehicle speed is fast and the vehicle is turning at the steering angle θ_{H} of, for example, −15 to +15 degrees, if the operation switches 2aL and 2aR are operated, the level of the steering correction operation can be small, which does not make the driver to feel strangeness.

This is because when the vehicle is turning at a fast speed, the driver typically grasps the steering wheel 2 relatively strongly and attempts to stabilize the turning of the vehicle against the reaction force from the road surface, and if the level of the steering correction operation through the operation switches 2aL and 2aR is large in such a case, the driver often feels strangeness.

<<Modified Example of Setting Range Rθ_{H} (Predetermined First Threshold) of Steering Angle θ_{H} Making Operation of Operation Switch Valid and Predetermined Second Threshold in accordance with Vehicle Speed>>

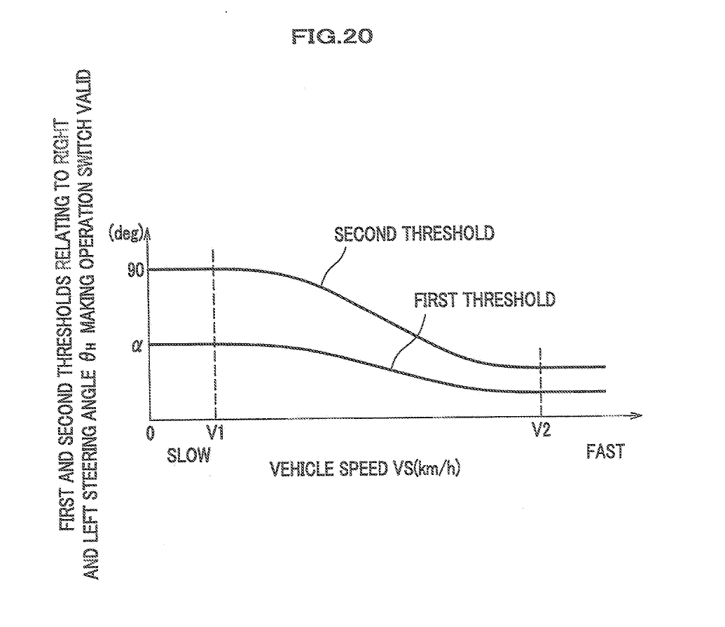

According to the first and second embodiments and the modified examples thereof, the range Rθ_{H} (the predetermined first threshold) of the steering angle θ_{H} that makes the operation to the operation switches 2aL and 2aR valid and the predetermined second threshold are fixed values, but the present invention is not limited to such setting. The operation switch validity determining unit 295 may obtain a signal indicating the vehicle speed VS as is indicated by dashed lines in FIGS. 3 and 13. FIG. 20 is an explanatory diagram for setting the range Rθ_{H} (the predetermined first threshold) of the steering angle θ_{H} that makes the operation to the operation switches 2aL and 2aR valid and the predetermined second threshold in accordance with the vehicle speed VS. Setting is made variable in accordance with the vehicle speed VS. As shown in FIG. 20, the range Rθ_{H} (the predetermined first threshold) of the steering angle θ_{H} that makes the operation to the operation switches 2aL and 2aR valid and the predetermined second threshold are constant values when the vehicle speed VS is equal to or slower than V1, e.g., substantially 40 km/h, decrease when the vehicle speed VS increases up to V2, and when the vehicle speed is equal to or faster than V2, e.g., substantially 100 km/h, fixed to predetermined saturated values that are constant values.

The data shown in FIG. 20 is stored in advance in the operation switch validity determining unit 295.

When the setting is made in accordance with the vehicle speed VS in such a way that the more the vehicle speed VS increases, the more the range Rθ_{H} (the predetermined first threshold) of the steering angle θ_{H} that makes the operation to the operation switches 2aL and 2aR valid and the predetermined second threshold decreases, the predetermined change level of the turning angle through the operation to the operation switches 2aL and 2aR is permitted during a turning of the vehicle with a turning radius that becomes larger as the vehicle speed VS becomes faster. This prevents the ride comfort from becoming poor due to a change in the lateral direction acceleration through an operation to the steering correction using the operation switches 2aL and 2aR while the vehicle is turning at a fast speed.

<<Modified Example of Operation Switch>>

According to the first and second embodiments and the modified examples thereof, the operation switches 2aL and 2aR provided at the steering wheel 2 are slide operation type, but the present invention is not limited to this type. For example, the operation switches 2aL and 2aR may be seesaw type which tilt when respective upper sides or lower sides are depressed to output a signal, and which return to a neutral position when not depressed by elastic force of a built-in spring, etc.

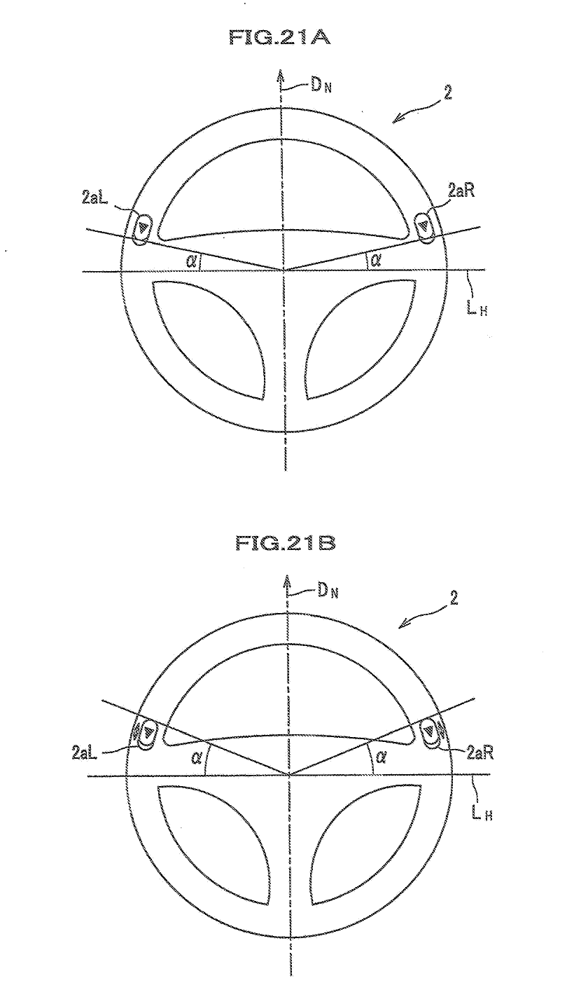

FIGS. 21A and 21B are explanatory diagrams for a modified example of the operation switches 2aL and 2aR provided at the steering wheel 2 in FIG. 1. As shown in FIG. 21, the operation switch 2aL may be exclusive for a steering correction operation in the left direction, and the operation switch 2aR may be exclusive for a steering correction operation in the right direction. Such operation switches 2aL and 2aR for a steering correction operation in one way may be push-button switches as shown in FIG. 21A or slide switches as shown in FIG. 21B.

Note that the angle α degrees considered when the range of Rθ_{H} of the valid steering angle θ_{H} is set is defined as same as FIG. 2.

<<Application of First and Second Embodiments and Modified Examples Thereof to Other Steering Devices>>

According to the first and second embodiments and the modified examples thereof, the steering device of a vehicle is the electric power steering device 100 that reduces a steering effort by the steering assist force of the motor 11 when the front wheels 10F, 10F are operated through the steering wheel 2, and the steering correction operation to the front wheels 10F, 1° F. are performed through the operation switches 2aL and 2aR. However, the present invention is not limited to such a steering device.

<Application to Steer-by-Wire Type Steering Device>

The additional current computing unit 300A or 300B according to the first and second embodiments and the modified examples thereof can be applied to a steer-by-wire type steering device that has the steering wheel 2 not mechanically coupled with the rack shaft 8 and not directly move such a shaft.

In a control device for a first motor (turning motor) that drives the rack shaft 8 to the right and left based on the steering angle θ_{H} of the steering wheel 2 and a second motor (turning reaction force motor) that applies turning reaction force to the steering wheel 2, when the current waveform of the additional current value I_{Ad} output by the additional current computing unit 300A or 300B according to the first and second embodiments and the modified examples thereof is added to the target current value for driving the first motor in accordance with an operation to the operation switches 2aL and 2aR, the same advantage can be easily obtained.

<Application to Steering Device with Steering-Angle-Ratio Variable Device>

With respect to a steering device having a steering-angle-ratio variable device that transmits the steering angle θ_{H} of the steering wheel 2 in a reduced or increased manner to the front wheels 10F, 10F, when the current waveform of the additional current value I_{Ad} output by the additional current computing unit 300A or 300B according to the first and second embodiments and the modified examples thereof is added in accordance with an operation to the operation switches 2aL and 2aR, the same advantage can be easily obtained.

<Application to Rear-Wheel Steering Device>

The additional current computing unit 300A or 300B of the first and second embodiments and modified examples thereof can be applied to a control device for a rear-wheel steering device that turns rear wheels in accordance with an operation to the steering wheel 2.

In this case, in the control device for the rear-wheel steering device, when the current waveform of the additional current value I_{Ad} output by the additional current computing unit 300A or 300B according to the first and second embodiments and the modified examples thereof is added, in accordance with an operation to the operation switches 2aL and 2aR, to a target rear-wheel turning current value for setting a target turning angle of the rear wheels in accordance with an operation to the steering wheel 2, the same advantage can be easily obtained.

In this case, the turning-angle target change level for the rear wheels is set to be smaller than the turning-angle target change level for the front wheels.

What is claimed is:

1. An electric steering device, comprising:
an operation unit including a steering wheel operated by a driver, a turning motor that turns turning wheels, and an operation unit which is provided at the steering wheel and which outputs an electric signal in accordance with an operation given by the driver; and
a control unit that controls the turning motor based on either one of or both of a steering operation to the steering wheel and the electric signal output by the operation unit, wherein
the control unit invalidates the electric signal output by the operation unit based on an operation given by the driver when a steering angle of the steering wheel to a right or a left exceeds a predetermined first threshold.

2. An electric steering device, comprising:
an operation unit including a steering wheel operated by a driver, a turning motor that turns turning wheels, and an operation unit which is provided at the steering wheel and which outputs an electric signal in accordance with an operation given by the driver; and
a control unit that controls the turning motor based on either one of or both of a steering operation to the steering wheel and the electric signal output by the operation unit, wherein
a plurality of the operation units are provided at the steering wheel, and
the control unit invalidates the electric signal output by at least one of the plurality of operation units based on an operation given by the driver when a steering angle of the steering wheel to a right or a left exceeds a predetermined first threshold.

3. The electric steering device according to claim 2, wherein
as the plurality of operation units, a right operation unit and a left operation unit are symmetrically provided at locations in a circumferential direction of the steering wheel with a neutral position direction of the steering wheel being as a symmetrical axis, and
the control unit
invalidates the electric signal output by the right operation unit based on an operation given by the driver when the steering angle to the right exceeds the predetermined first threshold in right turning of the steering wheel, and
invalidates the electric signal output by the left operation unit based on an operation given by the driver when the steering angle to the left exceeds the predetermined first threshold in left turning of the steering wheel.

4. The electric steering device according to claim 3, wherein
the control unit
stores in advance the predetermined first threshold of the steering angle and a predetermined second threshold of the steering angle to the right and left larger than the predetermined first threshold,
validates the electric signals output by either one of the right and left operation units when the steering angle to the right and left is equal to or smaller than the predetermined first threshold in turning of the steering wheel,
invalidates the electric signal output by the right operation unit based on the operation given by the driver when the steering angle to the right exceeds the predetermined first threshold but is equal to or smaller than the predetermined second threshold in right turning of the steering wheel,
invalidates the electric signal output by the left operation unit based on the operation given by the driver when the steering angle to the left exceeds the predetermined first threshold but is equal to or smaller than the predetermined second threshold in left turning of the steering wheel, and
invalidates the electric signal output by either one of the right and left operation units when the steering angle to either one of the right and the left exceeds the predetermined second threshold in turning of the steering wheel.

5. The electric steering device according to claim 1, wherein the control unit makes at least the predetermined first threshold variable in accordance with a vehicle speed.

6. The electric steering device according to claim 2, wherein the control unit makes at least the predetermined first threshold variable in accordance with a vehicle speed.

7. The electric steering device according to claim 1, wherein
the control unit comprises an additional current computing unit that calculates and outputs an additional current value waveform for adding a substantially rectangular pulse current for driving the turning motor in accordance with the electric signal output by the operation unit, and
the additional current computing unit generates and outputs, in accordance with driving condition information on a vehicle, the predetermined additional current value waveform in accordance with an operation given to the operation unit regardless of a length of an operation time of the operation unit by the driver.

8. The electric steering device according to claim 2, wherein
the control unit comprises an additional current computing unit that calculates and outputs an additional current value waveform for adding a substantially rectangular pulse current for driving the turning motor in accordance with the electric signal output by the operation unit, and
the additional current computing unit generates and outputs, in accordance with driving condition information on a vehicle, the predetermined additional current value waveform in accordance with an operation given to the operation unit regardless of a length of an operation time of the operation unit by the driver.

9. The electric steering device according to claim 7, further comprising a vehicle speed detecting unit that detects a vehicle speed,
wherein the additional current computing unit generates and outputs the predetermined additional current value waveform in accordance with the detected vehicle speed.

10. The electric steering device according to claim 8, further comprising a vehicle speed detecting unit that detects a vehicle speed,
wherein the additional current computing unit generates and outputs the predetermined additional current value waveform in accordance with the detected vehicle speed.

11. The electric steering device according to claim 7, wherein the faster the detected vehicle speed becomes, the more the additional current computing unit decreases a wave height of the additional current value waveform, and the slower the detected vehicle speed becomes, the more the additional current computing unit increases the wave height of the additional current value waveform.

12. The electric steering device according to claim 8, wherein the faster the detected vehicle speed becomes, the more the additional current computing unit decreases a wave height of the additional current value waveform, and the slower the detected vehicle speed becomes, the more the additional current computing unit increases the wave height of the additional current value waveform.

13. The electric steering device according to claim 7, wherein the faster the detected vehicle speed becomes, the more the additional current computing unit decreases a width of the additional current value waveform, and the slower the detected vehicle speed becomes, the more the additional current computing unit increases the width of the additional current value waveform.

14. The electric steering device according to claim 8, wherein the faster the detected vehicle speed becomes, the more the additional current computing unit decreases a width of the additional current value waveform, and the slower the detected vehicle speed becomes, the more the additional current computing unit increases the width of the additional current value waveform.

15. The electric steering device according to claim 7, further comprising a steering condition detecting unit that detects whether the operation to the operation unit is a steering increase condition or a return condition,
wherein the additional current computing unit
decreases a wave height or a width of the additional current value waveform when the detected steering condition is the return condition, and
increases the wave height or the width of the additional current value waveform when the detected steering condition is the steering increase condition.

16. The electric steering device according to claim 8, further comprising a steering condition detecting unit that detects whether the operation to the operation unit is a steering increase condition or a return condition,
wherein the additional current computing unit
decreases a wave height or a width of the additional current value waveform when the detected steering condition is the return condition, and
increases the wave height or the width of the additional current value waveform when the detected steering condition is the steering increase condition.

17. The electric steering device according to claim 1, further comprising:
a turning mechanism mechanically isolating a coupling of the turning wheels with the steering wheel;
the turning motor that drives the turning mechanism in accordance with a steering operation input through the steering wheel; and
a steering reaction force motor that applies steering reaction force to the steering wheel in accordance with the steering operation input through the steering wheel.

18. The electric steering device according to claim 2, further comprising:
a turning mechanism mechanically isolating a coupling of the turning wheels with the steering wheel;
the turning motor that drives the turning mechanism in accordance with a steering operation input through the steering wheel; and
a steering reaction force motor that applies steering reaction force to the steering wheel in accordance with the steering operation input through the steering wheel.
